(19) United States
(12) Patent Application Publication
(10) Pub. No.: US 2026/0040088 A1
(43) Pub. Date: Feb. 5, 2026

(54) SPECTRUM SHARING BETWEEN TWO RADIO ACCESS TECHNOLOGIES (RATS) IN A WIRELESS COMMUNICATION SYSTEM

(71) Applicant: Huawei Technologies Co., Ltd., Shenzhen (CN)

(72) Inventors: Hao Tang, Ottawa (CA); Jianglei Ma, Ottawa (CA); Wen Tong, Ottawa (CA)

(21) Appl. No.: 19/355,489

(22) Filed: Oct. 10, 2025

Related U.S. Application Data
(63) Continuation of application No. PCT/CN2023/099796, filed on Jun. 13, 2023.
(60) Provisional application No. 63/458,473, filed on Apr. 11, 2023.

(51) Int. Cl. H04W 16/14; H04W 72/044

(52) U.S. Cl. CPC H04W 16/14; H04W 72/044

(57) ABSTRACT

During wireless communication on a radio access technology (RAT) over a frequency band, there may be time-frequency resources on the frequency band that are not occupied. In some embodiments, time-frequency resources that are not occupied by wireless transmissions on a first RAT may be used for wireless transmissions on a second RAT. For example, a first RAT may perform wireless communication on a first frequency band, and a second RAT may perform wireless communication on a second frequency band. The first and second frequency bands may at least partially overlap in the frequency domain so that a wireless communication on the second RAT on the second frequency band may use time-frequency resources that are not occupied by wireless transmissions on the first RAT on the first frequency band.

### CROSS-REFERENCE TO RELATED APPLICATIONS

The present application is a continuation of International Application No. PCT/CN2023/099796, filed on Jun. 13, 2023, which claims the benefit of U.S. Provisional Patent Application No. 63/458,473, filed on Apr. 11, 2023, all of which are incorporated herein in their entireties by reference.

### TECHNICAL FIELD

The present application relates to wireless communication, and more specifically to spectrum sharing.

### BACKGROUND

In some wireless communication systems, electronic devices, such as user equipments (UEs), wirelessly communicate with a wireless network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a UE may wirelessly transmit information to a TRP in an uplink communication over a particular frequency (or range of frequencies) for a particular duration of time. The frequency and time duration are examples of resources, typically referred to as time-frequency resources. Other examples of resources may include resources in the spatial domain (e.g. the beam that is used), resources in the power domain (e.g. transmission power), etc.

The time-frequency resources may comprise resource elements (REs), resource blocks (RBs), and/or resource block groups (RBGs). A RE is the smallest physical time-frequency resource. In one implementation, a RE may consist of one frequency subcarrier (“subcarrier”) during one orthogonal frequency division multiplexing (OFDM) symbol. An RB is group of consecutive frequency resources. In one implementation, an RB may consist of a group of consecutive subcarriers in the frequency domain, e.g. an RB may be defined as 12 consecutive subcarriers in the frequency domain. An RBG is a group of RBs, e.g. an RBG may be defined as 16 consecutive RBs.

A wireless communication may be transmitted on a frequency band. The frequency band may alternatively be referred to as spectrum. An example of a wireless communication on a frequency band is a wireless communication transmitted on a carrier frequency, referred to herein as a carrier. A carrier may alternatively be referred to as a component carrier (CC) or cell in some implementations. A carrier may be characterized by its bandwidth and a reference frequency (e.g. center frequency) of the carrier. Another example of a wireless communication on a frequency band is a wireless communication transmitted on a bandwidth part (BWP). A BWP is a contiguous or non-contiguous set of frequency subcarriers. A carrier may include a BWP, or vice versa.

A radio access technology (RAT) is the underlying physical connection technology used for a wireless communication on a wireless network. A wireless communication may be said to occur on the RAT. Examples of RATs include: a third-generation (“3G”) RAT, a long-term evolution (LTE) RAT, a fourth-generation (“4G”) RAT, a fifth-generation new radio (“5G NR”) RAT, Wi-Fi, and Bluetooth. For example, a UE operating on a 5G wireless network uses 5G NR RAT (alternatively called 5G RAT or NR RAT), and the wireless communications occur on the 5G NR RAT, e.g. over a frequency band associated with the 5G NR RAT.

During wireless communication on a RAT over a frequency band, there may sometimes be time-frequency resources on the frequency band that are not occupied by the wireless communication.

### SUMMARY

A wireless network may be a multi-RAT network, which is a network that supports communicating on different RATs. For example, a multi-RAT network may include one or more TRPs that can communicate with both a first UE on a first RAT and a second UE on a second RAT. Time-frequency resources that are not occupied by wireless transmissions on the first RAT may be used for wireless transmissions on the second RAT. For example, a first RAT may perform wireless communication on a first frequency band, and a second RAT may perform wireless communication on a second frequency band. The first frequency band and the second frequency band may at least partially overlap in the frequency domain so that a wireless communication on the second RAT on the second frequency band may use time-frequency resources that are not occupied by wireless transmissions on the first RAT on the first frequency band. This results in the technical benefit of more efficient use of time-frequency resources through the sharing of spectrum, which is important because time-frequency resources are limited.

One example is as follows. As sixth generation (6G) RAT is deployed, there may still exist UEs that communicate using 5G NR RAT. A multi-RAT network may be deployed in which one or more TRPs communicate on 5G NR RAT with UEs having 5G capability (referred to as “5G UEs”), and on 6G RAT with UEs having 6G capability (referred to as “6G UEs”). Some or all of the wireless communication on the 5G NR RAT may occur on a first frequency band (referred to as a “5G frequency band”). Some or all of the wireless communication on the 6G RAT may occur on a second frequency band (referred to as a “6G frequency band”). The 6G frequency band may at least partially overlap with the 5G frequency band so that wireless communication on the 6G frequency band may use time-frequency resources on the 5G frequency band that are unoccupied. That is, wireless communication on the 6G RAT may use time-frequency resources that are on the 6G frequency band, that are also on the 5G frequency band (because the 5G and 6G frequency bands at least partially overlap), and that are not used for wireless transmission on the 5G NR RAT on the 5G frequency band.

A technical problem occurs when configuring (e.g. scheduling) a wireless communication to/from a 6G UE on the 6G frequency band on time-frequency resources that are also on the 5G frequency band. There are some wireless transmissions on the 5G frequency band that should not be interfered with, which means that a wireless communication on the 6G frequency band should not be configured on those time-frequency resources. These time-frequency resources will be referred to as prohibited resources, or alternatively, resources that are not available. As an example, time-frequency resources used on the 5G frequency band for synchronization on the 5G NR RAT, network access on the 5G NR RAT, transmission of control information on the 5G NR RAT, and/or transmission of a reference signal on the 5G NR RAT might be prohibited. For example, in some implementations it might be prohibited for a 6G UE to be scheduled on the 6G frequency band on time-frequency resources used on the 5G frequency band to send a synchronization signal block (SSB) to 5G UEs. However, some of these prohibited resources might only occupy some of the resource elements (REs) in one or more resource blocks (RBs). Therefore, to best utilize the spectrum, the 6G UE should be scheduled on the 6G frequency band on a RE-by-RE basis, so that when there is an RB that has both prohibited REs and non-prohibited/unoccupied REs, the non-prohibited/unoccupied REs can be scheduled without scheduling the prohibited REs. However, scheduling a 6G UE on a RE-by-RE basis results in too high control overhead. It is desired and/or necessary (depending upon the implementation) to instead schedule on an RB-by-RB basis and/or possibly on an RBG-by-RBG basis. However, if scheduling on an RB-by-RB basis, then the 6G UE cannot be scheduled on any RB that includes one or more prohibited resources, even if that RB only has some REs that are prohibited. Similarly, if scheduling on an RBG-by-RBG basis, then the 6G UE cannot be scheduled on any RBG including one or more prohibited resources, even if that RBG has only some REs and/or RBs that are prohibited. This results in time-frequency resources (e.g. REs) that are unoccupied on that 5G frequency band, but that are also not utilized for wireless communication on the 6G frequency band, which is a waste of time-frequency resources.

Therefore, in some embodiments, a wireless communication to/from a 6G UE on the 6G frequency band may be configured (e.g. scheduled) on time-frequency resources that are also on the 5G frequency band and that include both unoccupied time-frequency resources and prohibited time-frequency resources. The unoccupied time-frequency resources are time-frequency resources that are not used for a wireless transmission on the 5G NR RAT on the 5G frequency band. The prohibited resources time-frequency resources are time-frequency resources that might or will be used for a wireless transmission on the 5G NR RAT on the 5G frequency band, and that are to be avoided to prevent interference. By configuring (e.g. scheduling) a wireless communication to/from a 6G UE on the 6G frequency band on both unoccupied time-frequency resources and prohibited time-frequency resources, the technical benefit of lower control overhead may be achieved because the wireless communication can be configured on an RB-by-RB and/or RBG-by-RBG basis, rather than on a RE-by-RE basis, while still including RBs and/or RBGs having some prohibited time-frequency resources to increase spectrum sharing. Specifically, to achieve the technical benefit of more spectrum sharing, the 6G UE is configured (e.g. scheduled) to communicate on RBs and/or RBGs having some prohibited time-frequency resources (e.g. some prohibited REs), and control signaling is used to provide information to the 6G UE that allows for the 6G UE to determine which of those time-frequency resources (e.g. which REs) are prohibited. The 6G UE then wirelessly communicates on the time-frequency resources, as configured, but excludes (i.e. does not wirelessly communicate) on the particular time-frequency resources determined to be prohibited. Rate matching and/or puncturing may be used to perform the wireless communication to/from the 6G UE on the 6G frequency band on the time-frequency resources other than the prohibited time-frequency resources.

Two examples are as follows. In one example, a 6G UE is scheduled on the 6G frequency band on an RB-by-RB basis. The 6G UE is scheduled on RBs that include one or more REs used for transmission of an SSB on the 5G frequency band. However, the SSB does not occupy all of the REs in an RB. The 6G UE determines the REs on which the SSB is transmitted (e.g. using information received from the network), and the 6G UE does not perform the wireless communication on those REs. In another example, the 6G UE is scheduled on an RBG-by-RBG basis. The 6G UE is scheduled on one or more RBGs that include one or more REs used for transmission of an SSB on the 5G frequency band. However, the SSB does not occupy all RBs of an RBG. The 6G UE determines the RBs on which the SSB is transmitted (e.g. using information received from the network), and the 6G UE does not perform the wireless communication on those RBs. In this second example, it may be lower overhead to indicate to the 6G UE which RBs to avoid, rather than which REs to avoid, although it may result in some REs being unoccupied and not being used for the wireless communication on the 6G frequency band.

In some embodiments, the network may semi-statically indicate to the 6G UE which time-frequency resources are prohibited, and the network may dynamically indicate that a particular prohibited resource is actually not prohibited and is unoccupied and may be used, which may be useful in situations in which there is a pattern of prohibited resources that can be semi-statically indicated, but for some durations in time those prohibited resources are actually unoccupied.

The embodiments are not limited to spectrum sharing between 6G and 5G NR RATs. More generally, wireless communication on a second RAT may occur on time-frequency resources associated with a first RAT that are unoccupied. Also, the wireless communications do not necessarily have to be between a UE and one or more TRPs. A wireless communication might instead be between two UEs (e.g. sidelink) or two network devices such as two TRPs (e.g. backhaul).

In one aspect, there is provided a method performed by an apparatus, e.g. a UE. The method may include receiving an indication of first time-frequency resources associated with wireless transmissions on a first RAT (e.g. 5G NR RAT) on a first frequency band. The method may further include wirelessly communicating on a second RAT (e.g. 6G RAT) on a second frequency band. The second frequency band may at least partially overlap in the frequency domain with the first frequency band. The wirelessly communicating may occur on second time-frequency resources excluding the first time-frequency resources. For example, in some embodiments, the wirelessly communicating may include communicating on the second time-frequency resources excluding the first time-frequency resources by rate-matching or puncturing to exclude communicating on the first time-frequency resources. In some embodiments, the first frequency band comprises at least one of a first carrier or a first BWP. In some embodiments, the second frequency band comprises at least one of a second carrier or a second BWP.

In some embodiments, prior to the wirelessly communicating, the method includes receiving information configuring a wireless communication for the apparatus on the second RAT. The wireless communication is configured on both the second time-frequency resources and the first time-frequency resources. However, despite being configured on both the second time-frequency resources and the first time-frequency resources, the wirelessly communicating comprises performing the wireless communication on the second time-frequency resources excluding the first time-frequency resources, e.g. by rate matching or puncturing to exclude transmission on the first time-frequency resources. In some embodiments, receiving the information configuring the wireless communication comprises receiving scheduling information scheduling the wireless communication, the wireless communication scheduled on the second time-frequency resources and the first time-frequency resources. In some embodiments, the scheduling information schedules the wireless communication on at least one RB that includes first REs on the first time-frequency resources and second REs not on the first time-frequency resources, and the wirelessly communicating comprises performing the wireless communication on the second REs and not on the first REs. In some embodiments, the scheduling information schedules the wireless communication on a plurality of RBs, at least one of the RBs including at least some of the first time-frequency resources, and the wirelessly communicating comprises performing the wireless communication on the plurality of RBs excluding any RB that includes some or all of the first time-frequency resources.

In some embodiments, the first time-frequency resources correspond to one or more time-frequency locations associated with at least one of: synchronization on the first RAT, network access on the first RAT, control information on the first RAT, or a reference signal on the first RAT. In some embodiments, the first time-frequency resources correspond to at least one of: time-frequency location of one or more synchronization signal blocks (SSBs) of the first RAT; time-frequency location of one or more control resource sets (CORESETs) of the first RAT; time-frequency location of one or more channel-state information reference signals (CSI-RSs) of the first RAT; time-frequency location of one or more sounding reference signals (SRSs) of the first RAT; time-frequency location of one or more random access channels (RACHs) of the first RAT; or time-frequency location of one or more control channels of the first RAT. In some embodiments, the first time-frequency resources correspond to the time-frequency location of one or more SSBs of the first RAT, and the indication comprises: (i) a time-domain indication that indicates a time location of at least one SSB, and (ii) a frequency domain indication that indicates a frequency location of the at least one SSB. In some embodiments, the time-domain indication comprises an indication of at least one of: a frame timing of the first RAT; a subcarrier spacing (SCS) of the at least one SSB; a pre-defined candidate time-domain location of the at least one SSB for each SCS; a periodicity of the at least one SSB; or a transmitted synchronization signal (SS)/physical broadcast channel (PBCH) block on the first RAT. In some embodiments, the frequency-domain indication comprises at least one of: a center of the first frequency band; a bandwidth of the first frequency band; an SSB subcarrier offset; a lowest RB location of an SSB after the SSB subcarrier offset is resolved; or a lowest subcarrier location of an SSB after the SSB subcarrier offset is resolved.

In some embodiments, the indication is a first indication, and the first indication also indicates that third time-frequency resources are also associated with the wireless transmissions on the first RAT, where the third time-frequency resources are a subset of the second time-frequency resources and are different from the first time-frequency resources. In some embodiments, prior to the wirelessly communicating the method further includes receiving a second indication indicating that the third time-frequency resources are not being used for wireless transmission on the first RAT. The wirelessly communicating on the second time-frequency resources may include communicating on the third time-frequency resources. In some embodiments, the first indication is received in semi-static signaling and the second indication is received in downlink control information (DCI) or in a medium access control (MAC) control element (MAC-CE). In some embodiments, the wirelessly communicating comprises a first wireless communication on the second RAT, and the method further includes: receiving information configuring a second subsequent wireless communication on the second RAT, where the second subsequent wireless communication is configured on resources that include a subset of time-frequency resources that were also indicated, in the first indication, as being associated with the wireless transmissions on the first RAT; and performing the subsequent wireless communication, but excluding communicating on the subset of time-frequency resources. In some embodiments, prior to performing the subsequent wireless communication, the method includes receiving a further indication indicating that it is prohibited for the apparatus to perform the subsequent wireless communication on the subset of time-frequency resources. In some embodiments, the further indication is received in DCI or in a MAC-CE.

In some embodiments, the second RAT is associated with both a first SSB time-frequency location pattern and a second SSB time-frequency location pattern for transmission of SSBs on the second RAT on the second frequency band. In some embodiments, the method further includes receiving, at the apparatus, an indication of whether the first SSB time-frequency location pattern or the second SSB time-frequency location pattern is being used. In some embodiments, receiving the indication of whether the first SSB time-frequency location pattern or the second SSB time-frequency location pattern is being used further includes receiving an indication of at least one of: a frequency location of an SSB, a time location of an SSB, a carrier on which an SSB is located, or a BWP on which an SSB is located. In some embodiments, the indication is received in a paging message. In some embodiments, the apparatus uses a reference signal for coarse synchronization in order to receive the paging message. In some embodiments, the first SSB time-frequency location pattern includes SSBs transmitted on the second RAT on the second frequency band on different frequency resources than SSBs transmitted on the first RAT on the first frequency band. In some embodiments, the second SSB time-frequency location pattern includes SSBs transmitted on the second RAT on the second frequency band on frequency resources that at least partially overlap with the frequency resources of SSBs transmitted on the first RAT on the first frequency band, but multiplexed in time. In some embodiments, for a given duration of time, more SSBs are transmitted in the first SSB time-frequency location pattern than in the second SSB time-frequency location pattern.

In some embodiments, an apparatus is provided to perform any of the methods described above and herein. For example, the apparatus includes at least one processor and a memory storing processor-executable instructions that, when executed by the at least one processor, cause the apparatus to perform any of the methods described above and herein. For example, the processor-executable instructions, when executed by the at least one processor, may cause the apparatus to: receive an indication of first time-frequency resources associated with wireless transmissions on a first RAT on a first frequency band; and wirelessly communicate on a second RAT on a second frequency band, the second frequency band at least partially overlapping in the frequency domain with the first frequency band; wherein the wirelessly communicating is to occur on second time-frequency resources excluding the first time-frequency resources. In some embodiments, the apparatus comprises a chip, e.g. an integrated circuit (IC) chip. In some embodiments, the apparatus does not execute instructions by a processor to perform the methods, e.g. the apparatus may comprise circuitry such as a field-programmable gate array (FPGA), a graphical processing unit (GPU), or an application-specific integrated circuit (ASIC), that performs the methods. More generally, the apparatus may comprise modules or units to perform the methods, e.g. a unit or module to receive an indication of first time-frequency resources associated with wireless transmissions on a first RAT on a first frequency band, and a unit or module to wirelessly communicate on a second RAT on a second frequency band, the second frequency band at least partially overlapping in the frequency domain with the first frequency band, and the wirelessly communicating occurring on second time-frequency resources excluding the first time-frequency resources. In some embodiments, the apparatus may include means for performing the method steps, e.g. the apparatus may comprise a means to receive an indication of first time-frequency resources associated with wireless transmissions on a first RAT on a first frequency band, and a means to wirelessly communicate on a second RAT on a second frequency band, the second frequency band at least partially overlapping in the frequency domain with the first frequency band, and the wirelessly communicating occurring on second time-frequency resources excluding the first time-frequency resources.

In another aspect, there is provided a method performed by a device, e.g. a network device such as a TRP. The method may include transmitting, to an apparatus (e.g. a UE), an indication of first time-frequency resources associated with wireless transmissions on a first RAT (e.g. a 5G NR RAT) on a first frequency band. The method may further include wirelessly communicating with the apparatus on a second RAT (e.g. a 6G RAT) on a second frequency band. The second frequency band may at least partially overlap in the frequency domain with the first frequency band. The wirelessly communicating may occur on second time-frequency resources excluding the first time-frequency resources. For example, in some embodiments, the wirelessly communicating may include communicating on the second time-frequency resources excluding the first time-frequency resources by rate-matching or puncturing to exclude communicating on the first time-frequency resources. In some embodiments, the first frequency band comprises at least one of a first carrier or a first BWP. In some embodiments, the second frequency band comprises at least one of a second carrier or a second BWP.

In some embodiments, prior to the wirelessly communicating, the method may include transmitting information configuring a wireless communication for the apparatus on the second RAT, the wireless communication configured on both the second time-frequency resources and the first time-frequency resources. The wirelessly communicating may include performing the wireless communication on the second time-frequency resources excluding the first time-frequency resources. In some embodiments, transmitting the information configuring the wireless communication comprises transmitting scheduling information scheduling the wireless communication, the wireless communication scheduled on the second time-frequency resources and the first time-frequency resources. In some embodiments, the scheduling information schedules the wireless communication on at least one RB that includes first REs on the first time-frequency resources and second REs not on the first time-frequency resources, and the wirelessly communicating comprises performing the wireless communication on the second REs and not on the first REs. In some embodiments, the scheduling information schedules the wireless communication on a plurality of RBs, at least one of the RBs including at least some of the first time-frequency resources, and the wirelessly communicating comprises performing the wireless communication on the plurality of RBs excluding any RB that includes some or all of the first time-frequency resources.

In some embodiments, the first time-frequency resources correspond to one or more time-frequency locations associated with at least one of: synchronization on the first RAT, network access on the first RAT, control information on the first RAT, or a reference signal on the first RAT. In some embodiments, the first time-frequency resources correspond to at least one of: time-frequency location of one or more synchronization signal blocks (SSBs) of the first RAT; time-frequency location of one or more control resource sets (CORESETs) of the first RAT; time-frequency location of one or more channel-state information reference signals (CSI-RSs) of the first RAT; time-frequency location of one or more sounding reference signals (SRSs) of the first RAT; time-frequency location of one or more random access channels (RACHs) of the first RAT; or time-frequency location of one or more control channels of the first RAT. In some embodiments, the first time-frequency resources correspond to the time-frequency location of one or more SSBs of the first RAT, and the indication comprises: (i) a time-domain indication that indicates a time location of at least one SSB, and (ii) a frequency domain indication that indicates a frequency location of the at least one SSB. In some embodiments, the time-domain indication comprises an indication of at least one of: a frame timing of the first RAT; a subcarrier spacing (SCS) of the at least one SSB; a pre-defined candidate time-domain location of the at least one SSB for each SCS; a periodicity of the at least one SSB; or a transmitted synchronization signal (SS)/physical broadcast channel (PBCH) block on the first RAT. In some embodiments, the frequency-domain indication comprises at least one of: a center of the first frequency band; a bandwidth of the first frequency band; an SSB subcarrier offset; a lowest RB location of an SSB after the SSB subcarrier offset is resolved; or a lowest subcarrier location of an SSB after the SSB subcarrier offset is resolved.

In some embodiments, the indication is a first indication, where the first indication also indicates that third time-frequency resources are also associated with the wireless transmissions on the first RAT, and where the third time-frequency resources are a subset of the second time-frequency resources and are different from the first time-frequency resources. In some embodiments, prior to the wirelessly communicating the method further includes transmitting a second indication indicating that the third time-frequency resources are not being used for wireless transmission on the first RAT. In some embodiments, the wirelessly communicating on the second time-frequency resources includes communicating on the third time-frequency resources. In some embodiments, the first indication is transmitted in semi-static signaling and the second indication is transmitted in downlink control information (DCI) or in a medium access control (MAC) control element (MAC-CE). In some embodiments, the wirelessly communicating comprises a first wireless communication on the second RAT, and the method further includes: transmitting information configuring a second subsequent wireless communication on the second RAT, wherein the second subsequent wireless communication is configured on resources that include a subset of time-frequency resources that were also indicated, in the first indication, as being associated with the wireless transmissions on the first RAT; and performing the subsequent wireless communication, but excluding communicating on the subset of time-frequency resources. In some embodiments, prior to performing the subsequent wireless communication, the method includes transmitting a further indication indicating that it is prohibited for the apparatus to perform the subsequent wireless communication on the subset of time-frequency resources. In some embodiments, the further indication is transmitted in DCI or in a MAC-CE.

In some embodiments, the second RAT is associated with both a first SSB time-frequency location pattern and a second SSB time-frequency location pattern for transmission of SSBs on the second RAT on the second frequency band. In some embodiments, the method further includes transmitting, to the apparatus, an indication of whether the first SSB time-frequency location pattern or the second SSB time-frequency location pattern is being used. In some embodiments, transmitting the indication of whether the first SSB time-frequency location pattern or the second SSB time-frequency location pattern is being used further includes transmitting an indication of at least one of: a frequency location of an SSB, a time location of an SSB, a carrier on which an SSB is located, or a BWP on which an SSB is located. In some embodiments, the indication is transmitted in a paging message. In some embodiments, the first SSB time-frequency location pattern includes SSBs transmitted on the second RAT on the second frequency band on different frequency resources than SSBs transmitted on the first RAT on the first frequency band. In some embodiments, the second SSB time-frequency location pattern includes SSBs transmitted on the second RAT on the second frequency band on frequency resources that at least partially overlap with the frequency resources of SSBs transmitted on the first RAT on the first frequency band, but multiplexed in time. In some embodiments, for a given duration of time, more SSBs are transmitted in the first SSB time-frequency location pattern than in the second SSB time-frequency location pattern.

In some embodiments, a device is provided to perform any of the methods described above and herein. For example, the device includes at least one processor and a memory storing processor-executable instructions that, when executed by the at least one processor, cause the device to perform any of the methods described above and herein. For example, the processor-executable instructions, when executed by the at least one processor, may cause the device to: transmit, to an apparatus, an indication of first time-frequency resources associated with wireless transmissions on a first RAT on a first frequency band; and wirelessly communicate with the apparatus on a second RAT on a second frequency band, the second frequency band at least partially overlapping in the frequency domain with the first frequency band, where the wirelessly communicating occurs on second time-frequency resources excluding the first time-frequency resources. In some embodiments, the device comprises a chip, e.g. an integrated circuit (IC) chip. In some embodiments, the device does not execute instructions by a processor to perform the methods, e.g. the device may comprise circuitry such as a field-programmable gate array (FPGA), a graphical processing unit (GPU), or an application-specific integrated circuit (ASIC), that performs the methods. More generally, the device may comprise modules or units to perform the methods, e.g. a unit or module to transmit, to an apparatus, an indication of first time-frequency resources associated with wireless transmissions on a first RAT on a first frequency band, and a unit or module to wirelessly communicate with the apparatus on a second RAT on a second frequency band, the second frequency band at least partially overlapping in the frequency domain with the first frequency band, and wherein the wirelessly communicating occurs on second time-frequency resources excluding the first time-frequency resources. In some embodiments, the device may include means for performing the method steps, e.g. the device may comprise a means to transmit, to an apparatus, an indication of first time-frequency resources associated with wireless transmissions on a first RAT on a first frequency band, and means to wirelessly communicate with the apparatus on a second RAT on a second frequency band, the second frequency band at least partially overlapping in the frequency domain with the first frequency band, and wherein the wirelessly communicating occurs on second time-frequency resources excluding the first time-frequency resources.

According to an aspect of the disclosure, there is provided a non-transitory computer readable storage medium, wherein the computer readable storage medium stores instructions that, when executed by a processor of an apparatus, enable the apparatus to perform a method as described above.

Technical benefits of some embodiments include the sharing of spectrum between two RATs, with reduced control overhead compared to scheduling on a RE-by-RE basis. The spectrum sharing provides more efficient use of scare time-frequency resources, and the reduced control overhead allows for more time-frequency resources to be dedicated to transmission of data.

### BRIEF DESCRIPTION OF THE DRAWINGS

Embodiments will be described, by way of example only, with reference to the accompanying figures wherein:

FIG. 1 is a network diagram of an example communication system;

FIG. 2 is a block diagram of an example electronic device;

FIG. 3 is a block diagram of another example electronic device;

FIG. 4 is a block diagram of example component modules;

FIG. 5 illustrates four carriers on a frequency band, according to one example;

FIG. 6 illustrates a device and a plurality of apparatuses, according to one embodiment;

FIG. 7 illustrates frequency bands over which wireless communication occurs, according to one embodiment;

FIG. 8 illustrates some examples of frequency band overlap;

FIG. 9 illustrates two frequency bands that partially overlap, according to one embodiment;

FIG. 10 illustrates six RBs scheduled for a wireless communication, according to one example;

FIG. 11 illustrates prohibited REs located within the RBs;

FIG. 12 illustrates a method performed by a device and apparatus, according to one embodiment;

FIG. 13 illustrates an example of the first time-frequency resources and the second time-frequency resources from the method of FIG. 12;

FIG. 14 illustrates an example of excluding any RB that includes first time-frequency resources;

FIGS. 15 to 19 illustrate release of resources, according to various examples; and

FIGS. 20 and 21 illustrate SSB patterns, according to various examples.

### DETAILED DESCRIPTION

For illustrative purposes, specific example embodiments will now be explained in greater detail below in conjunction with the figures.

The methods described herein may be implemented in a communication system that implements wireless communication. Therefore, an example communication system that includes wireless communication is first described below.

### Example Communication Systems and Devices

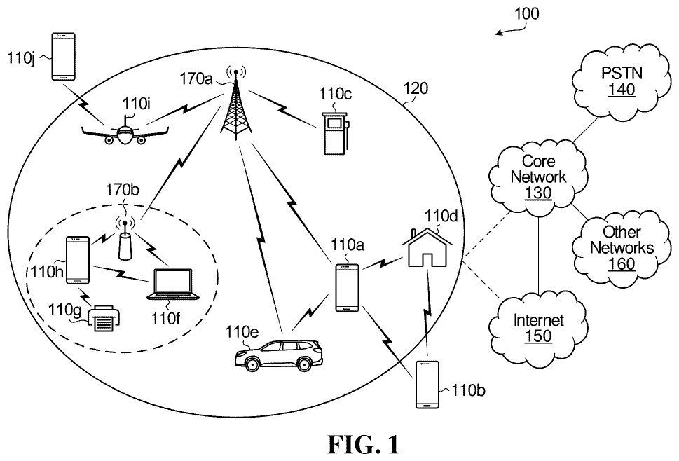

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

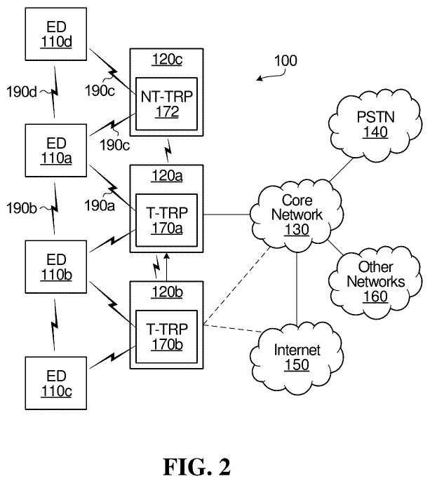

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the Eds 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of Eds and one or multiple NT-TRPs for multicast transmission.

The RANs 120a and 120b are in communication with the core network 130 to provide the Eds 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANS 120a and 120b or Eds 110a 110b, and 110c or both, and (ii) other networks (such as the PSTN 140, the internet 150, and the other networks 160). In addition, some or all of the Eds 110a 110b, and 110c may include functionality for communicating with different wireless networks over different wireless links using different wireless technologies and/or protocols. Instead of wireless communication (or in addition thereto), the Eds 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). Eds 110a 110b, and 110c may be multimode devices capable of operation according to multiple radio access technologies, and incorporate multiple transceivers necessary to support such.

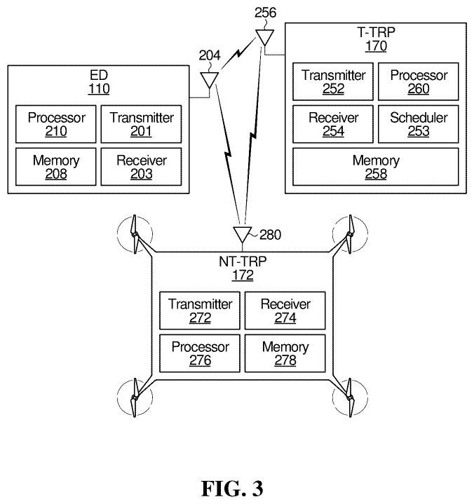

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation Eds 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

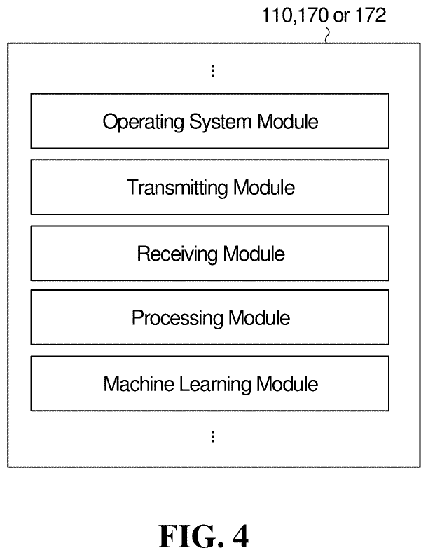

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is discussed herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH, downlink control information (DCI) sent in a PDCCH, or sidelink control information (SCI) sent in a physical sidelink control channel (PSCCH). A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling such as RRC signaling and/or a MAC CE. Dynamic signaling, as used herein, may refer to signaling that is dynamic, e.g. physical layer control signaling sent in the physical layer, such as DCI sent in a PDCCH, UCI sent in a PUCCH, or SCI sent in a PSCCH.

A wireless communication may be transmitted on a frequency band. The frequency band may alternatively be referred to as spectrum. An example of a wireless communication on a frequency band is a wireless communication on a carrier frequency, referred to herein as a carrier. A carrier may alternatively be referred to as a component carrier (CC) or cell in some implementations. A carrier may be characterized by its bandwidth and a reference frequency, e.g. the center or lowest or highest frequency of the carrier. Another example of a wireless communication on a frequency band is a wireless communication transmitted on a bandwidth part (BWP). A BWP may be defined as a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers. Therefore, in some embodiments, a carrier may have one or more BWPs, but the vice versa could instead be the case.

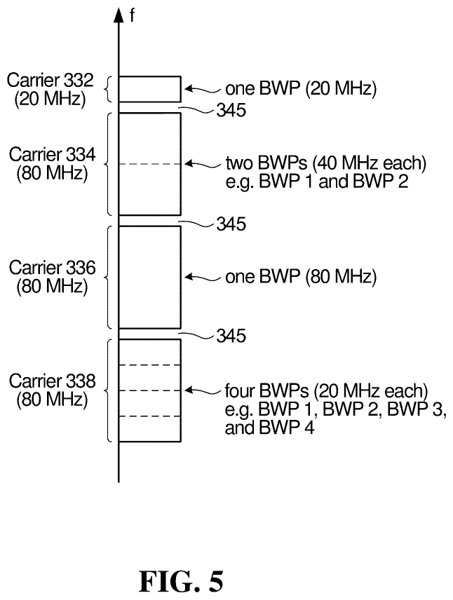

For the sake of example, FIG. 5 illustrates four carriers on a frequency band. The frequency band might include more or fewer carriers, e.g. the frequency band may include and be defined by the bandwidth of a single carrier. The four carriers are respectively labelled carriers 332, 334, 336, and 338. The four carriers are contiguous with each other, except that a guard band 345 may be interposed between adjacent pairs of contiguous carriers. Carrier 332 has a bandwidth of 20 MHz and consists of one BWP. Carrier 334 has a bandwidth of 80 MHz and consists of two adjacent contiguous BWPs, each BWP being 40 MHz, and respectively identified as BWP 1 and BWP 2. Carrier 336 has a bandwidth of 80 MHz and consists of one BWP. Carrier 338 has a bandwidth of 80 MHz and consists of four adjacent contiguous BWPs, each BWP being 20 MHz, and respectively identified as BWP 1, BWP 2, BWP 3, and BWP 4. As mentioned above, in other embodiments, a BWP may include one or multiple carriers. In general, a frequency band may include or consist of one or more carriers and/or may include or consist of one or more BWPs, and if both a carrier and a BWP is included in the frequency band, then the BWP might be included in some or all of the carrier, or the carrier might be included in some or all of the BWP.

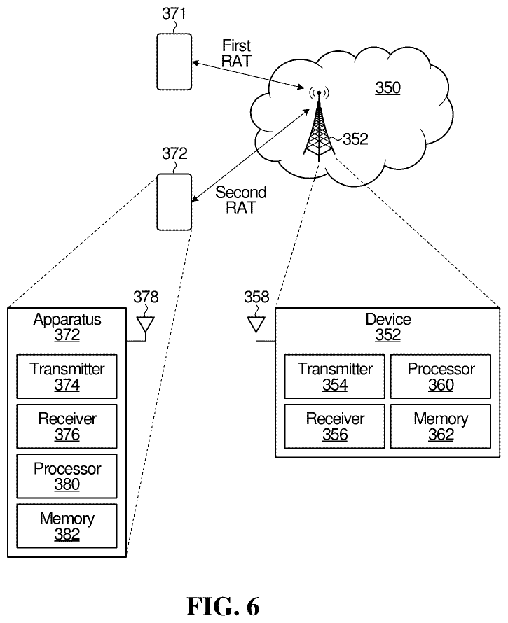

FIG. 6 illustrates a device 352 and a plurality of apparatuses 371 and 372, according to one embodiment. Only two apparatus apparatuses 371 and 372 are illustrated, but there may be more than two. Note that the terms “apparatus” and “device” are simply labels used to distinguish between different entities more easily. An apparatus and a device are not necessarily different types of entities, e.g. an apparatus and a device might both be the same type of entity (e.g. they may both be a UE or a TRP).

In the illustrated embodiment, the device 352 is part of a network 350 (e.g. acting as an access point to the network 350) and the device 352 may be referred to as a network device. For example, the device 352 may be a TRP, such as T-TRP 170 or NT-TRP 172. The device 352 might actually be implemented by a plurality of network devices, e.g. a plurality of TRPs, that communicate with the apparatuses 371 and 372, perhaps one TRP communicating with apparatus 371 and a different TRP communicating with apparatus 372.

The network 350 is a multi-RAT network, and the device 352 can communicate with both apparatus 371 on a first RAT and apparatus 372 on a different second RAT. Alternatively, the network does not necessarily have to be multi-RAT, e.g. there may be two different networks, one for each RAT, and the device 352 could span the two different networks, communicating with apparatus 371 on the first network on the first RAT, and communicating with the apparatus 372 on the second network on the second RAT.

In some embodiments, the parts of the device 352 may be distributed. For example, some of the modules of the device 352 may be located remote from the equipment housing the antennas and/or panels of the device 352, and may be coupled to the equipment housing the antennas/panels over a communication link (not shown). Therefore, in some embodiments, the term device 352 may also or instead refer to one or more modules (e.g. an integrated circuit) on the network side that perform processing operations, such as scheduling, message generation, encoding/decoding, etc., and that are not necessarily part of the equipment housing the antennas and/or panels of the device 352.

The device 352 is shown to include a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. The processor 360 of the device 352 performs (or controls the device 352 to perform) much of the operations described herein as being performed by the device 352, e.g. generating and transmitting the indication of first time-frequency resources associated with wireless transmissions on the first RAT, wirelessly communicating with apparatus 372 on the second RAT, rate-matching and/or puncturing, configuring (e.g. scheduling) a wireless communication for the apparatus 372 on the second RAT, etc. Wirelessly communicating with apparatus 372 may refer to transmitting a wireless communication from the device 352 to the apparatus 372, or receiving a wireless communication from the apparatus 372, or both transmitting a wireless communication to and receiving a wireless communication from the apparatus 372. Wireless communication involving a transmission from the device 352 to the apparatus 372 may involve generation of information (e.g. data and/or control information) by arranging the information in a message format, encoding the message, modulating, performing beamforming (as necessary), etc. Wireless communication involving receiving a transmission from the apparatus 372 may involved performing beamforming (as necessary), demodulating and decoding the received messages, etc.

Although not illustrated, the processor 360 may form part of the transmitter 354 and/or receiver 356. The device 352 further includes a memory 362 for storing information (e.g. control information and/or data).

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the device 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the device 352 is NT-TRP 172, then the transmitter 354 may be or include transmitter 272, the receiver 356 may be or include receiver 274, the processor 360 may be or include processor 276, and the memory 362 may be or include memory 278.

The apparatus 372 is also illustrated in more detail in FIG. 6. The apparatus 372 includes a transmitter 374 and receiver 376, which may be integrated as a transceiver. The transmitter 374 and receiver 376 are coupled to one or more antennas 378. Only one antenna 378 is illustrated. One, some, or all of the antennas may alternatively be panels. The processor 380 of the apparatus 372 performs (or controls the apparatus 372 to perform) much of the operations described herein as being performed by the apparatus 372, e.g. receiving the indication of first time-frequency resources associated with wireless transmissions on the first RAT, wirelessly communicating with the device 352 on the second RAT, rate-matching and/or puncturing, configuring a wireless communication on the second RAT according to configuration information (e.g. scheduling information) received from the device 352, etc. Wirelessly communicating with device 352 may refer to transmitting a wireless communication from the apparatus 372 to the device 352, or receiving a wireless communication from the device 352, or both transmitting a wireless communication to and receiving a wireless communication from the device 352. Wireless communication involving a transmission from the apparatus 372 to the device 352 may involve generation of information (e.g. data and/or control information) by arranging the information in a message format, encoding the message, modulating, performing beamforming (as necessary), etc. Wireless communication involving receiving a transmission from the device 352 may include performing beamforming (as necessary), demodulating and decoding the received messages, etc.

Although not illustrated, the processor 380 may form part of the transmitter 374 and/or receiver 376. The apparatus 372 further includes a memory 382 for storing information (e.g. control information and/or data).

The processor 380 and processing components of the transmitter 374 and receiver 376 may be implemented by the same or different one or more processors that are configured to execute instructions stored in a memory (e.g. in memory 382). Alternatively, some or all of the processor 380 and/or processing components of the transmitter 374 and/or receiver 376 may be implemented using dedicated circuitry, such as a programmed FPGA, a GPU, or an ASIC.

If the apparatus is a UE or other ED 110, then the transmitter 374 may be or include transmitter 201, the receiver 376 may be or include receiver 203, the processor 380 may be or include processor 210, and the memory 382 may be or include memory 208. If the apparatus 372 is a NT-TRP 172 (e.g. a drone), then the transmitter 374 may be or include transmitter 272, the receiver 376 may be or include receiver 274, the processor 380 may be or include processor 276, and the memory 382 may be or include memory 278.

Although the apparatus 371 is not illustrated in detail in FIG. 6, the apparatus 371 may have the same components as apparatus 372. Also, although the device 352 is illustrated in FIG. 6 as a T-TRP, the device 352 need not be a T-TRP (e.g. it could be a NT-TRP), and more generally the device 352 need not even be a TRP. Moreover, although the apparatus 372 is illustrated in FIG. 6 as a UE served by the network 350, the apparatus 372 need not be a UE. For example, the device 352 and apparatus 372 might be two entities communicating over sidelink or over backhaul. Therefore, “device 352” and “apparatus 372” are used more generally herein, rather than referring to TRPs and UEs.

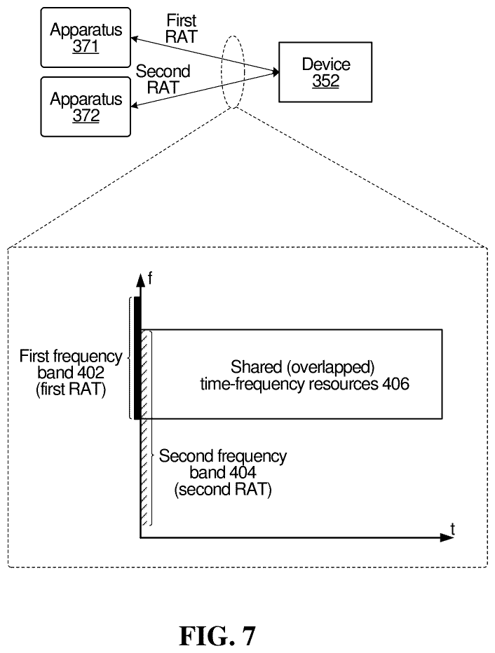

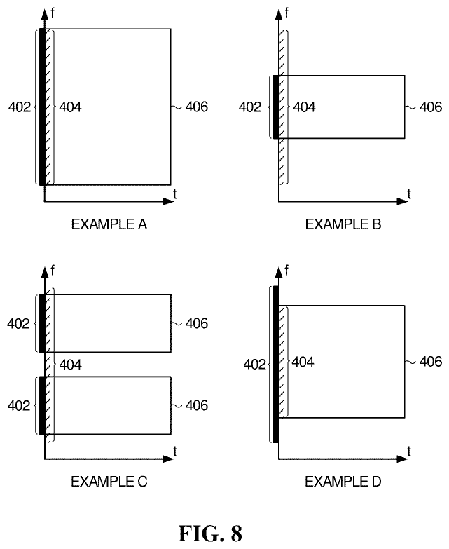

FIG. 7 illustrates frequency bands over which wireless communication occurs, according to one embodiment. The device 352 wirelessly communicates with the apparatus 371 on a first RAT (e.g. 5G NR RAT) over a first frequency band 402. The device 352 also wirelessly communicates with the apparatus 372 on a second RAT (e.g. 6G RAT) over a different second frequency band 404. The two frequency bands at least partially overlap, such that there are time-frequency resources 406 shared by both the first frequency band 402 and the second frequency band 404. The overlapping portion of the two frequency bands will be referred to as the shared spectrum. FIG. 7 illustrates the second frequency band 404 only partially overlapping in the frequency domain with the first frequency band 402. In general, the second frequency band 404 at least partially overlaps in the frequency domain with the first frequency band 402, but the second frequency band 404 might encompass the first frequency band 402 or vice versa, or the frequency bands may be the same. FIG. 8 illustrates some examples of frequency band overlap, which are not meant to be exhaustive. In Example A, the first frequency band 402 and the second frequency band 404 are the same. In Example B, the second frequency band 404 encompasses the first frequency band 402. In Example C, the second frequency band 404 encompasses the first frequency band 402, and the first frequency band 402 consists of two non-contiguous portions (e.g. two different carriers or BWPs). In Example D, the first frequency band 402 encompasses the second frequency band 404. Although not illustrated in FIGS. 7 and 8, it could be the case that there are portions of time in which there is no overlap in the frequency domain, e.g. if communication on the first frequency band 402 starts and/or ends at a different time from communication on the second frequency band 404. The illustrated examples only show the time when overlap occurs in the time domain and the frequency domain.

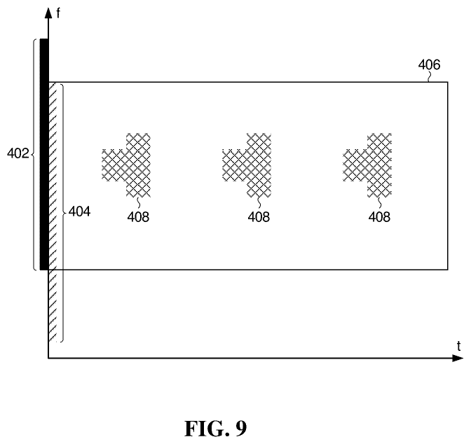

FIG. 9 illustrates the first frequency band 402 and second frequency band 404 of FIG. 7 in which, for generality, the two frequency bands only partially overlap. In general, the two frequency bands at least partially overlap, but one may encompass the other, or they may be the same. The first frequency band 402 is used for wireless transmission on the first RAT, and the second frequency band 404 is used for wireless transmission on the second RAT. There are overlapped (shared) time-frequency resources 406, which is shared spectrum in which there may be wireless communication on either the first RAT on the first frequency band 404 or on the second RAT on the second frequency band 404. In some embodiments, the first RAT may have priority and may be free to configure wireless communication on any of the overlapped resources 406. Wireless communication on the second RAT on the second frequency band 404 on the overlapped resources 406 then only occurs on time-frequency resources that are not occupied by a wireless communication on the first RAT on the first frequency band 402.

On the overlapped time-frequency resources 406, there are time-frequency resources 408 reserved for wireless communication on the first RAT on the first frequency band 402. These time-frequency resources 408 might or might not actually be used for wireless communication on the first RAT on the first frequency band 402, but to avoid interference it is prohibited to perform a wireless communication on these time-frequency resources 408 on the second RAT on the second frequency band 404. The time-frequency resources 408 will therefore be referred to as the prohibited resources 408.

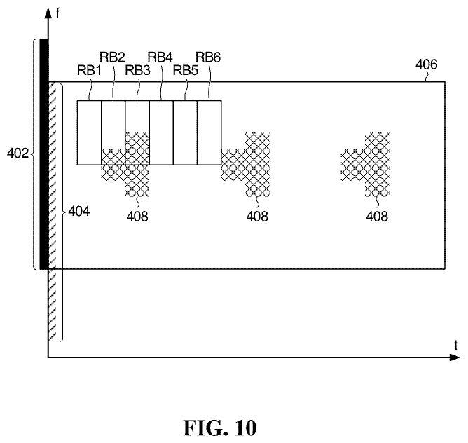

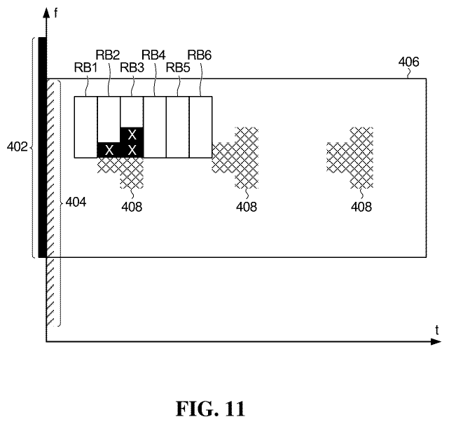

A wireless communication may be configured (e.g. scheduled) on the second RAT on the second frequency band 404 on the overlapped resources 406, including possibly on the prohibited resources 408. For example, FIG. 10 illustrates six resource blocks (RBs) scheduled for a wireless communication on the second RAT on the second frequency band 404. The RBs are labelled RB1 to RB6. RB2 and RB3 each include one or more REs that are prohibited, i.e. that are part of prohibited resources 408. With reference to FIG. 11, the prohibited REs located within the RBs are illustrated as black boxes with white X's. Although the RBs configured (e.g. scheduled) for the wireless communication include some prohibited REs, the wireless communication on the RBs on the second RAT on the second frequency band 404 does not use the prohibited REs. Instead, communication is excluded on (i.e. not performed on) those prohibited REs. For example, rate-matching or puncturing may be performed to exclude communicating on the prohibited REs. The device 352 knows the time-frequency location of the prohibited REs, e.g. because the device 352 configures all wireless communications on both frequency bands 402 and 404, or alternatively the device 352 can obtain, over backhaul, the time-frequency location of the prohibited REs from another network device (e.g. associated with the first RAT). Therefore, the device 352 is aware of which resources are unoccupied and prohibited on the first frequency band 402. The device 352 can then avoid communicating on the prohibited REs. However, the apparatus 372 does not know about the prohibited REs without being told. The apparatus 372 has been configured (e.g. scheduled) to communicate on the 6 RBs, even though some of those RBs include the prohibited REs, and the apparatus 372 will communicate on all REs of the RBs (including the prohibited REs), unless the apparatus 372 is informed of the prohibited REs within the configured RBs. Therefore, the device 352 informs the apparatus 372 of the time-frequency location of the prohibited resources 408. The apparatus 372 then knows that the RBs include some REs that are part of the prohibited resources 408, and the apparatus 372 does not communicate on those REs. The device 352 may inform the apparatus 372 of the time-frequency location of the prohibited resources 408 by sending an indication of the time-frequency location of the prohibited resources 408. The indication may be sent in control signaling. The indication might be an explicit indication of the time-frequency location of the prohibited resources 408, or (to reduce the amount of information that needs to be transmitted), the indication may consist of information that can be used by the apparatus 372 (possibly in combination with other information the apparatus 372 already knows) in order for the apparatus 372 to derive the time-frequency location of the prohibited resources 408. With knowledge of the time-frequency location of the prohibited resources 408, the apparatus 372 excludes transmitting on the prohibited REs in the RBs. The apparatus 372 may use rate-matching or puncturing to conform the number of bits to the number of time-frequency resources available on the 6 RBs, minus the prohibited REs.

The wireless communication for the apparatus 372 is configured on an RB-by-RB basis (or RBG-by-RBG basis), e.g. the apparatus 372 receives DCI scheduling the 6 RBs. This saves control signaling overhead compared to having to configure the wireless communication for the apparatus 372 on an RE-by-RE basis to schedule around the prohibited REs. Additional control signaling is sent to the apparatus 372 to either directly or indirectly indicate the time-frequency location of the prohibited resources 408, so that the apparatus 372 can exclude communicating on the prohibited REs within the RBs. However, this additional control signaling indicating the time-frequency location of the prohibited resources 408 is less than the control signaling alternatively required to schedule on an RE-by-RE basis. For example, the indication of the prohibited resources 408 may be indicated semi-statically in advance only one, e.g. if there is a known repeating pattern of the prohibited resources 408. Additionally or alternatively, the apparatus 372 may be able to determine the location of the prohibited resources 408 using information stored a priori at the apparatus 372, e.g. using information in a look-up table, with the additional control signaling just indicating the information which is missing/needed for the apparatus 372 to determine exactly the location of the prohibited resources 408.

In the example explained above, spectrum sharing is maximized because wireless communication is performed on all unoccupied (non-prohibited) REs in the RBs, and this is achieved using control signaling overhead that is less than the amount of control signaling overhead required to try to schedule the wireless communication on an RE-by-RE basis.

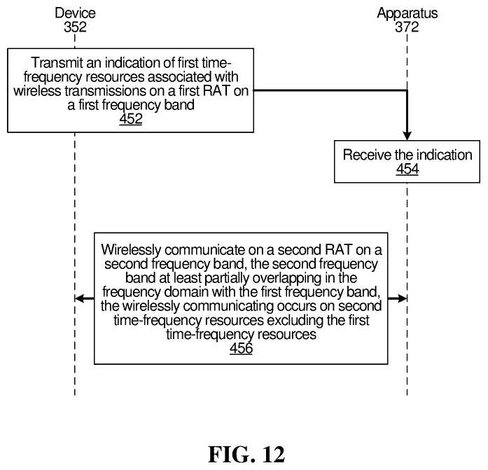

FIG. 12 illustrates a method performed by the device 352 and the apparatus 372, according to one embodiment. At step 452, the device 352 transmits, to the apparatus 372, an indication of first time-frequency resources associated with wireless transmissions on the first RAT on the first frequency band 402. The first frequency band 402 may include a carrier and/or a BWP. The first RAT might be, for example, 5G NR RAT.

At step 454, the apparatus 372 receives the indication. At step 456, the device 352 and the apparatus 372 wirelessly communicate on the second RAT on the second frequency band 404. The second frequency band 404 may include a carrier and/or a BWP. The second RAT might be, for example, 6G RAT.

The second frequency band 404 at least partially overlaps in the frequency domain with the first frequency band 402. The wirelessly communicating occurs on second time-frequency resources excluding the first time-frequency resources.

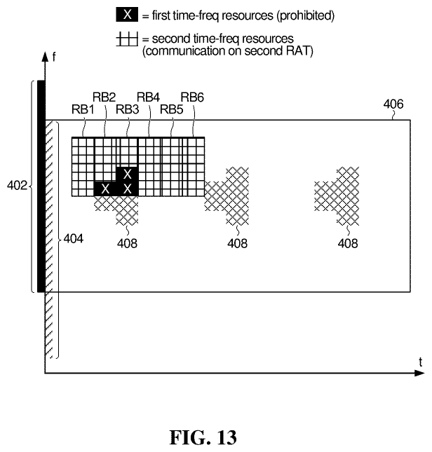

Continuing the examples introduced earlier, FIG. 13 illustrates an example of the first time-frequency resources and the second time-frequency resources from the method of FIG. 12. The first frequency band 402 and the second frequency band 404 at least partially overlap, to result in the overlapped time-frequency resources 406. The overlapped time-frequency resources 406 is shared spectrum. The wirelessly communication on the second RAT on the second frequency band 404 is the 6 RBs. The first time-frequency resources are the prohibited REs shown using black boxes with X's. The second time-frequency resources are the other REs in the RBs, excluding the prohibited REs. The second time-frequency resources are illustrated using hatching in the RBs. The wirelessly communicating occurs on second time-frequency resources (the hatching in the RBs) excluding the first time-frequency resources (the black boxes with X's).

In some embodiments of the method of FIG. 12, the indication of the first time-frequency resources might be indicated by indicating a set of time-frequency resources that are prohibited, the set of time-frequency resources including the first time-frequency resources. For example, with reference to FIG. 13, the indication transmitted in step 452 (and received in step 454) may comprise an indication of the time-frequency location of the prohibited resources 408, where the prohibited resources 408 include the first time-frequency resources.

In some embodiments of the method of FIG. 12, the indication of the first time-frequency resources is a direct indication of the time-frequency location of the first time-frequency resources, whereas in other embodiments the indication of the first time-frequency resources is indirect, e.g. the indication may consist of information that can be used by the apparatus 372 (possibly in combination with other information the apparatus 372 already knows) in order for the apparatus 372 to derive the time-frequency location of the first time-frequency resources, which may save overhead compared to directly indicating the location of the first time-frequency resources.

In some embodiments of the method of FIG. 12, the wirelessly communicating in step 456 is performed by communicating on the second time-frequency resources excluding the first time-frequency resources by rate-matching and/or puncturing to exclude communicating on the first time-frequency resources.

Rate-matching is implemented by modifying the coding rate to reduce the total number of bits transmitted, in order to match the number of bits to the second time-frequency resources. For example, with reference to FIG. 13, although 6 RBs are configured for communicating on the second RAT on the second frequency band 404, not all of the bits configured to be transmitted on the 6 RBs can be transmitted because the first time-frequency resources (the prohibited REs in RBs 2 and 3) cannot be used to transmit bits. Rate matching may be implemented to modify the coding rate to reduce the total number of bits to be transmitted on the 6 RBs, so that all of the bits can be transmitted. The total number of bits is reduced by an amount corresponding to the number of bits that would be transmitted on the prohibited REs, but cannot be transmitted because those REs are prohibited. In one implementation of rate matching, the device 352 determines the modified coding rate and indicates the modified coding rate to the apparatus 372 so that the apparatus 372 can implement the modified coding rate when performing channel encoding (if the apparatus 372 is transmitting) or channel decoding (if the apparatus 372 is receiving).

Puncturing is implemented by discarding (not transmitting) the bits that are configured to be transmitted on the first time-frequency resources. For example, with reference to FIG. 13, although 6 RBs are configured for communicating on the second RAT on the second frequency band 404, not all of the bits configured to be transmitted on the 6 RBs can be transmitted because the first time-frequency resources (the prohibited REs in RBs 2 and 3) cannot be used to transmit bits. Puncturing may be implemented to discard the bits that were to be transmitted on the prohibited REs in RBs 2 and 3. The transmitting entity (whether it be the device 352 or the apparatus 372, depending upon the direction of the wireless communication) discards the bits that were to be transmitted on the prohibited REs in RBs 2 and 3, and then does not transmit anything on those prohibited REs. The receiving entity (i.e. the other one of the device 352 or the apparatus 372, depending upon the direction of wireless communication) does not discard bits, but simply does not receive (or decode) on the prohibited REs, and instead decodes using only the bits received on the second time-frequency resources.

If puncturing of all of the first time-frequency resources, it is not necessary to modify the coding rate, i.e. it is not necessary to also perform rate matching. The opposite is also true. However, in general, both rate matching and puncturing could both be implemented. In any case, the result is to exclude transmitting on the first time-frequency resources (the prohibited resources in the RBs). It may be preconfigured or predefined as to whether rate matching is to be performed or puncturing is to be performed.

In some embodiments of the method of FIG. 12, prior to the wirelessly communicating in step 456, the method may further include receiving information configuring (e.g. scheduling) a wireless communication for the apparatus 372 on the second RAT, where the wireless communication is configured (e.g. scheduled) on both the second time-frequency resources and the first time-frequency resources. That is, the wireless communication is not configured to avoid the first time-frequency resources. However, the wirelessly communicating in step 456 comprises performing the wireless communication on the second time-frequency resources excluding the first time-frequency resources. In this way, overhead may be saved in configuring (e.g. scheduling) the wireless communication because it is not necessary to configure (e.g. schedule) around the first time-frequency resources. For example, with reference to FIG. 13, the wireless communication is configured (scheduled) on the 6 RBs. The configuration may be on an RB-by-RB (or RBG-by-RBG) basis. Therefore, all the time-frequency resources of the 6 RBs are configured (e.g. scheduled) for the communication, including both the first time-frequency resources (the black boxes with X's) and the second time-frequency resources (the hatched portion of the RBs). However, the actual communication in step 456 does not occur on all of the configured time-frequency resources, but instead the communication excludes the first time-frequency resources (the black boxes with X's). The device 352 and apparatus 372 both know the time-frequency location of the first time-frequency resources and know they are prohibited, and so do not the communicate on the first time-frequency resources. In this way, overhead may be saved in configuring (e.g. scheduling) the wireless communication of step 456 because it is not necessary to configure (e.g. schedule) on an RE-by-RE basis to avoid the REs that are prohibited (the black boxes with X's). Moreover, spectrum sharing is increased because the REs in RBs 2 and 3 that are not prohibited are used for the wireless communication.

In some embodiments, the information configuring the wireless communication of step 456 is scheduling information, e.g. RBs 1 to 6 in FIG. 13 are scheduled by the device 352. The wireless communication is scheduled on both the second time-frequency resources and the first time-frequency resources to save scheduling overhead, e.g. RBs 1 to 6 in FIG. 13 are scheduled on an RB-by-RB or RBG-by-RBG basis. “Scheduling”, as used herein, refers to scheduling a communication in any direction (e.g. uplink, downlink, sidelink), and the scheduling may be via a grant, or may be without grant, and/or the scheduling may be dynamic (e.g. in DCI) or semi-static.

In some embodiments, the scheduling information schedules the wireless communication on at least one RB that includes first REs on the first time-frequency resources and second REs not on the first time-frequency resources, and the wirelessly communicating includes performing the wireless communication on the second REs and not on the first REs. For example, in FIG. 13, 6 RBs are scheduled for the wireless communication. RB 3 includes both REs on the first time-frequency resources (i.e. prohibited REs) and REs not on the first time-frequency resources (i.e. REs on the second-time frequency resources). The wireless communication excludes communicating on the REs on the first time-frequency resources.

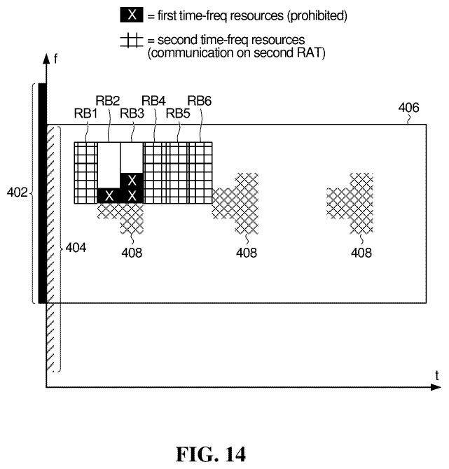

In some embodiments, the scheduling information schedules the wireless communication on a plurality of RBs, at least one of the RBs including at least some of the first time-frequency resources. The wirelessly communicating of step 456 then comprises performing the wireless communication on the plurality of RBs excluding any RB that includes some or all of the first time-frequency resources. In some embodiments, N RBs in M symbols may be declared as not available (prohibited), where N and M are integers. FIG. 14 illustrates an example of excluding any RB that includes first time-frequency resources. FIG. 14 is a variation of FIG. 13 in which the 6 RBs are scheduled for the wireless communication, perhaps even on an RBG-by-RBG basis (e.g., an RBG might include 6 consecutive RBs, and a single RBG might have been scheduled). The first time-frequency resources (the prohibited REs) are in RBs 2 and 3. Therefore, communication is excluded on RBs 2 and 3. The second time-frequency resources (shown in hatching) are RBs 1, 4, 5, and 6. The drawback is that spectrum sharing is not as optimal because the time-frequency resources in RBs 2 and 3 that are not prohibited are not used, which means they stay unoccupied. Moreover, more aggressive rate matching and/or puncturing is required to limit the communication to just RBs 1, 4, 5, and 6. However, the benefit may be reduced overhead in indicating, to the apparatus 372, the time-frequency location of the prohibited resources, e.g. instead of having to indicate the time-frequency location of the prohibited resources 408 at the granularity of REs, the indication may just indicate RBs that are prohibited, where each prohibited RB includes one or more prohibited REs. For example, the indication may indicate that N RBs in M symbols are prohibited, where N and M are integers.

Note that the information configuring the wireless communication of step 456 does not necessarily have to be scheduling information, e.g. RBs 1 to 6 in FIG. 13 do not need to have been scheduled by the device 352. More generally, the wireless communication of step 456 may have been configured, which might not involve scheduling per se. For example, RBs 1 to 6 in FIG. 13 may be RBs on a control channel configured for the 6G UE for transmission of downlink or uplink control information. As another example, RBs 1 to 6 in FIG. 13 may be RBs that are configured for transmission of a reference signal. Configured communications such as these might not be scheduled per se.

In some embodiments, the first time-frequency resources correspond to one or more time-frequency locations associated with at least one of: synchronization on the first RAT, network access on the first RAT, control information on the first RAT, or a reference signal on the first RAT. For example, in some embodiments, the first time-frequency resources correspond to at least one of:
Time-frequency location of one or more synchronization signal blocks (SSBs) of the first RAT, e.g. the prohibited resources 408 are where SSBs are configured to be transmitted on the first RAT on the first frequency band 402; and/or
Time-frequency location of one or more control resource sets (CORESETs) of the first RAT, e.g. the prohibited resources 408 are where DCI is configured to be transmitted on the first RAT on the first frequency band 402; and/or
Time-frequency location of one or more channel-state information reference signals (CSI-RSs) of the first RAT, e.g. the prohibited resources 408 are where CSI-RSs are configured to be transmitted on the first RAT on the first frequency band 402; and/or
Time-frequency location of one or more sounding reference signals (SRSs) of the first RAT, e.g. the prohibited resources 408 are where SRSs are configured to be transmitted on the first RAT on the first frequency band 402; and/or
Time-frequency location of one or more random access channels (RACHs) of the first RAT, e.g. the prohibited resources 408 correspond to the time-frequency location of one or more RACHs of the first RAT on the first frequency band 402; and/or
Time-frequency location of one or more control channels of the first RAT, e.g. the prohibited resources 408 correspond to the time-frequency location of one or more control channels (e.g. PUCCH, PDCCH) of the first RAT on the first frequency band 402.

Some specific examples of the indication transmitted in step 452 and received in step 454 of FIG. 12 will now be provided. The examples assume that the first RAT (corresponding to the first frequency band 402) is 5G NR, and that the second RAT (corresponding to the second frequency band 404) is 6G. However, the examples need not be limited to 5G NR and 6G.

### EXAMPLE 1

The first time-frequency resources correspond to the time-frequency location of one or more SSBs that are configured for transmission in 5G NR on the first frequency band 402. The indication transmitted in step 452 and received in step 454 of FIG. 12 provides an indication that allows for the apparatus 372 to determine the time-frequency location of these first time-frequency resources (i.e. the time-frequency location of these one or more SSBs). In the example, the apparatus 372 is a 6G UE, i.e. a UE that is communicating on 6G RAT. In the example, the device 352 is a 6G TRP, i.e. a TRP that can communicate with the 6G UE on 6G RAT. In the example, the first frequency band 402 is a 5G NR carrier and the second frequency band 404 is a 6G carrier.

The 6G TRP indicates, to the 6G UE, the 5G NR SSB configuration in the shared spectrum, i.e. the time-frequency location of the one or more SSBs that are configured for transmission in 5G NR on the first frequency band 402. The 6G TRP indicates the REs of the 5G NR SSB in the shared spectrum to the 6G UE, so that the 6G UE can rate match (and/or puncture) around the 5G NR SSB, e.g. rate match the REs for the 5G NR SSB to avoid interference between 5G and 6G. There are some available unused REs in the 5G NR SSBs. The total number of available REs is non-negligible due to periodic SSB beam sweeping. The 6G UE may dynamically use these available REs.

In this Example 1, the 6G TRP may indicate the time-domain location of a 5G NR SSB in the shared spectrum to the 6G UE, and the indication of the time-domain location may include one, some, or all of the following parameters (the specific parameters needed to be indicated may depend upon the implementation):
Frame timing of the 5G NR carrier, e.g. the boundary of the 5G NR frame or half-frame. This parameter might need to be indicated if the frame boundary of 6G and 5G is not aligned.
Subcarrier spacing (SCS) of the 5G NR SSB. The SCS may need to be indicated if the candidate SSB locations are a function of the SCS. In one option, the SCS may be determined by the 6G UE based on the band of the shared spectrum, according to Table 5.4.3.3-1 (Applicable SS raster entries per operating band) in 3GPP TS 38.101-1 V18.0.0. The 6G UE can find the SS Block SCS in the shared spectrum band. If there are two available SCSs, the 6G TRP indicates which SCS is used by the 5G NR carrier.
Pre-defined candidate time-domain locations of 5G NR SSB for each 5G NR SSB SCS. As shown in section 4.1 of the 5G spec 3GPP TS 38.213, for a half frame with SS/PBCH blocks, the first symbol indexes for candidate SS/PBCH blocks may be determined according to the SCS of SS/PBCH blocks.
Periodicity of 5G NR SSB. For example, the periodicity of the 5G NR SSB burst set may be indicated, E.g. 5 ms, 10 ms, 20 ms, 40 ms, 80 ms, 160 ms. In some embodiments, if this parameter is not indicated to the 6G UE, the 6G UE applies the value 5 ms.
Actually Transmitted 5G NR SS/PBCH Block. For a candidate time-domain location of 5G NR SSB, the 5G NR SSB might not be transmitted on the 5G carrier. In one option, a bitmap may be used to indicate the actual SS/PBCH block transmission, e.g. where one bit corresponds to one candidate location of an SSB. In another option, the indication may be in compressed form (e.g. in above 6 GHz case): Group-bitmap (8 bits)+bitmap in Group (8 bits), 64 SSBs are in 8 groups, each group has 8 SSBs.

In this Example 1, the 6G TRP may also or instead indicate the frequency-domain location of a 5G NR SSB in the shared spectrum to the 6G UE.

One option is for the 6G TRP to provide a direct indication of the 5G NR SSB location in the frequency domain. One way to do this may be to indicate the Global Synchronization Channel Number (GSCN) of the 5G NR SSB. For example, as shown in TS 38.101-1 v18.0.0, in 5G NR, a global synchronization raster is defined for all frequencies. The frequency position of the synchronization signal (SS) block is defined as SSREF with corresponding number GSCN. The parameters defining the SSREF and GSCN for all the frequency ranges are in Table 5.4.3.1-1 of TS 38.101-1 v18.0.0, which is shown below for completeness:

TABLE
GSCN parameters for the global frequency raster

| Frequency | SS Block frequency | | Range of |
|---|---|---|---|
| range | position SS_{REF} | GSCN | GSCN |
| 0-3000 | N * 1200 kHz + M * 50 kHz, | 3N + | 2-7498 |
| MHz | N = 1:2499, M ∈ {1, 3, 5} | (M − 3)/2 | |
| | (Note 1) | | |
| 3000-24250 | 3000 MHz + N * 1.44 MHz | 7499 + N | 7499-22255 |
| MHz | N = 0:14756 | | |

(NOTE):
The default value for operating bands with which only support SCS spaced channel raster(s) is M = 3.

The GSCN identifies the position of resource element RE=#0 (subcarrier #0) of resource block RB #10 of the SS block. Therefore, by the GSCN, the 6G UE could find the exact frequency location of NR SSB. The 6G TRP may indicate the GSCN, and from that the 6G UE may determine M and N in the table above.

Another way to provide a direct indication of the 5G NR SSB location in the frequency domain is to indicate the frequency location of the lowest or highest subcarrier of the 5G NR SSB. For example, indicate an offset from a frequency reference point, where the offset may be RB granularity or subcarrier granularity or a combination of RB and subcarrier granularity.

Instead of the 6G TRP providing, to the 6G UE, a direct indication of the 5G NR SSB location in the frequency domain, the 6G TRP may indicate one or more parameters that allows for the 6G UE to derive the 5G NR SSB location in the frequency domain. For example, the 6G TRP may indicate the 5G NR carrier information in the shared spectrum and indicate the 5G NR SSB location in the 5G NR carrier by indicating one or more parameters that allow for the 6G UE to derive the 5G NR SSB location in the frequency domain. This may save overhead (result in an indication of fewer bits) compared to the 6G TRP providing a direct indication of the 5G NR SSB location in the frequency domain. One, some, or all of the following parameters may be indicated to the 6G UE to allow for the 6G UE to derive the 5G NR SSB location in the frequency domain (the specific parameters needed to be indicated may depend upon the implementation):
Center of the 5G NR carrier. For example, the 5G NR carrier center subcarrier location, e.g. indicate an offset from a reference point to the center subcarrier of the NR carrier, or indicate an Absolute Radio-Frequency Channel Number (ARFCN) of the center of NR carrier.
5G NR carrier bandwidth.
SSB Subcarrier Offset (k_{ssb}). This corresponds to k_{SSB} (from 3GPP TS 38.213), which is the frequency domain offset between the SSB and the overall resource block grid in number of subcarriers, i.e. offset between the edge of the SS/PBCH RBs and the edge of the data RBs.
Lowest RB location (or lowest subcarrier location) of the SSB after the SSB Subcarrier Offset (K_{ssb}) is resolved (i.e. SSB is shifted k_{ssb} subcarriers in frequency domain). One option is to indicate the Lowest RB index (Common RB index, or Physical RB index), and also indicate the Common RB 0 or Physical RB 0 location, e.g. reference point of the subcarrier 0 of Common RB 0 or Physical RB 0. Another option is to indicate the lowest frequency location of an SSB, e.g. indicate an offset from a reference point

The time and/or frequency location indications discussed above in relation to this Example 1 may be transmitted from the 6G TRP to the 6G UE using RRC, MAC-CE, or DCI signalling.

Once the time-frequency location of the one or more SSBs is indicated to the 6G UE, the 6G UE may rate match around the 5G NR SSB(s). One option is RE-level rate matching. That is, the 6G UE could use REs not occupied by NR SSBs, which may maximize the spectrum efficiency. Another option is RB-level rate matching. That is, for an RB in the 6G carrier, if one or multiple REs are occupied by 5G NR SSB(s), the RB is rate matched by the 6G UE. This option is simpler to implement because the whole RB is excluded if one or more REs of the RB are occupied by an NR SSB, but it will waste some REs (the REs are not used and remain unoccupied), thereby decreasing the spectrum efficiency.

If RB-level rate matching around the 5G NR SSB(s) is implemented for the 6G UE, then another lower-overhead method may be used to indicate the time and frequency location of a 5G NR SSB:
Time-domain location of 5G NR SSB: the same as described above.
Frequency-domain location of 5G NR SSB: Indicate the frequency location of lowest subcarrier or lowest RB of 5G NR SSB, e.g. indicate the RB index in 6G carrier for the lowest location of NR SSB. Indicate the number of RBs occupied by the 5G NR SSB, e.g. 20 or 21 RBs with the SCS of 5G NR SSB. If this indication is not included, then the 6G UE may assume the value to be 20 (or 21, depending on what is configured for the 6G UE). Since the SSB occupies 20 or 21 RBs, the 6G TRP only needs to indicate the lowest (starting) RB index and whether 20 or 21 RB. From this, the 6G UE then knows the whole SSB. The result is a lower indication overhead (compared to indicating the SSB at an RE-level), but the drawback is that whole RBs are being rate-matched, even if those RBs only have some REs of an SSB, and so it is not as efficient from a spectrum sharing perspective.

Instead of rate matching in Example 1, puncturing may be implemented.

In Example 1, rate matching or puncturing is being performed to exclude the resources on which an SSB is transmitted in 5G NR. The example assumes the communication between the 6G TRP and the 6G UE is downlink, which means the 6G TRP excludes transmitting, in the downlink, on the SSB resources (via rate matching and/or puncturing), and the 6G UE receives and decodes the communication on the configured resources excluding the SSB resources. However, more generally, the communication between the 6G UE and the 6G TRP could involve uplink communication, e.g. if the 6G UE and 6G TRP both support full duplex.

### EXAMPLE 2

The first time-frequency resources correspond to the time-frequency location of some or all of 5G NR CORESET0. CORESET0 is a type of control resource set (CORESET) which carries PDCCH/DCI for SIB1. A number of consecutive resource blocks and a number of consecutive symbols are configured for the CORESET of the Typeo-PDCCH common search space (CSS) set (i.e. CORESET0). In the example, the apparatus 372 is a 6G UE, i.e. a UE that is communicating on 6G RAT. In the example, the device 352 is a 6G TRP, i.e. a TRP that can communicate with the 6G UE on 6G RAT. In the example, the first frequency band 402 is a 5G NR carrier and the second frequency band 404 is a 6G carrier.

The indication transmitted in step 452 and received in step 454 of FIG. 12 provides an indication that allows for the 6G UE to determine the time-frequency location of these first time-frequency resources (i.e. the time-frequency location of 5G NR CORESET0). The 6G UE may then rate match and/or puncture to exclude communicating on any REs (and/or RBs) occupied by 5G NR CORESET0.

In a first option, the 6G TRP directly indicates the RBs and symbols of the 5G NR CORESET0. The frequency-domain location may be indicated by indicating the starting RB of CORESET0 and the length of CORESET0. The time-domain location may be indicated by indicating the symbol locations of CORESET0 and the periodicity of CORESET0. Note that in the frequency-domain, one or multiple CORESET0 may be indicated to 6G UEs.

In a second option, the 6G TRP indicates the time-frequency location of the NR SSB block and the corresponding CORESET0. Indication of the location of the SSB block may be performed in the way described in Example 1 above. For the corresponding CORESET0 indication, one, some, or all of the following information may be indicated (the specific information needed to be indicated may depend upon the implementation):
The existence of a 5G NR CORESET0. This may need to be indicated because if the SSB is not cell-defined SSB in NR, there is no corresponding NR CORESET0.
The frequency-domain location of CORESET0 if there is a corresponding CORESET. The 6G TRP may indicate the SSB SCS, and PDCCH for SIB1 SCS (note SIB1, PDCCH for SIB1 and CORESET0 have the same SCS). According to {SSB, PDCCH} SCS, the 6G UE can find the exact used table for CORESET0 configuration from Table 13-1 to Table 13-10 in 3GPP TS 38.213 V17.4.0. The configuration index in the exact used table for CORESET0 configuration may be indicated. According to the index (e.g. 4 bits for the index), the 6G UE can find the row in the table for CORESET0 configuration, i.e. can obtain the frequency location of CORESET0 and time duration of CORESET0. Note that the configuration index may be regarded as Information Element (IE) control ResourceSetZero in 3GPP TS 38.331.
The time-domain location of CORESET0 if there is a corresponding CORESET. The 6G TRP may indicate the SSB SCS, and PDCCH for SIB1 SCS (note SIB1, PDCCH for SIB1 and CORESET0 have the same SCS). According to {SSB, PDCCH} SCS, the 6G UE can find the exact used table for PDCCH monitoring occasions in CORESET0. The time configuration index in the exact used table may be indicated. According to the index (e.g. 4 bits for the index), the 6G UE can find the row in the table for PDCCH monitor occasion for SIB1, i.e. can obtain the time-domain location (including periodicity) for PDCCH in CORESET0. Note that the time configuration index can be regarded as IE searchSpaceZero in 3GPP TS 38.331.

The second option mentioned above may have less overhead compared to the first option, in terms of number of bits needed to be transmitted from the 6G TRP to the 6G UE to indicate the time-frequency location of CORESET0. This may be the case, for example, when the 6G TRP already indicated information that allowed the 6G UE to determine the time-frequency location of the 5G NRs SSBs (Example 1 above). Some of that information may be reused to determine the time-frequency location of CORESET0.

In some embodiments of Example 2, in addition the 6G TRP also indicates, to the 6G UE, the 5G NR Common RB 0 or Physical RB 0 location, e.g. the frequency location of the subcarrier 0 of Common RB 0 or Physical RB 0.

In Example 2, rate matching or puncturing is being performed to exclude the resources on which a CORESET0 is transmitted in 5G NR. The example assumes the communication between the 6G TRP and the 6G UE is downlink, which means the 6G TRP excludes transmitting, in the downlink, on the CORESET0 resources (via rate matching and/or puncturing), and the 6G UE receives and decodes the communication on the configured resources excluding the CORESET0 resources. However, more generally, the communication between the 6G UE and the 6G TRP could involve uplink communication, e.g. if the 6G UE and 6G TRP both support full duplex.

### EXAMPLE 3

The first time-frequency resources correspond to the time-frequency location of a 5G NR channel state information reference signal (CSI-RS). In the example, the apparatus 372 is a 6G UE, i.e. a UE that is communicating on 6G RAT. In the example, the device 352 is a 6G TRP, i.e. a TRP that can communicate with the 6G UE on 6G RAT. In the example, the first frequency band 402 is a 5G NR carrier and the second frequency band 404 is a 6G carrier.

The indication transmitted in step 452 and received in step 454 of FIG. 12 provides an indication that allows for the 6G UE to determine the time-frequency location of these first time-frequency resources (i.e. the time-frequency location of a 5G NR CSI-RS). The 6G UE may then rate match and/or puncture to exclude communicating on any REs (and/or RBs) occupied by a 5G NR CSI-RS.

The 6G TRP may indicate the 5G NR carrier information in the shared spectrum to the 6G UE, including the center frequency of the 5G NR carrier, the 5G NR carrier bandwidth, and/or the center of the subcarrier 0 of a common resource block or a PRB, and/or the frame timing (e.g. boundary of a frame/subframe/slot). This indication may be needed if the time-frequency location of the 5G NR CSI-RS is based on the 5G NR carrier information.

The 6G TRP may indicate the REs occupied by the 5G NR CSI-RS to the 6G UE, so that the 6G UE can rate match around and/or puncture these REs. To indicate the RE mapping of a CSI-RS resource in the time and frequency domain, one, some or all of the following information may be indicated (where the exact information indicated is dependent upon the implementation):
frequencyDomainAllocation, e.g. frequency domain allocation within a physical resource block in accordance with TS 38.211, clause 7.4.1.5.3.
nrofPorts, i.e. number of antenna ports (since different numbers of ports may have different reference signal locations).
firstOFDMSymbolInTimeDomain, e.g. time domain allocation within a physical resource block (PRB). The field indicates the first OFDM symbol in the PRB used for CSI-RS. See TS 38.211, clause 7.4.1.5.3.
firstOFDMSymbolInTimeDomain2, e.g. time domain allocation within a PRB. See TS 38.211, clause 7.4.1.5.3.
cdm-Type, i.e. code division multiplexing (CDM) type (e.g. as per TS 38.214, clause 5.2.2.3.1), since different CDM types may map to different reference signal locations.
Density, e.g. the density of CSI-RS resource measured in RE/port/PRB (see TS 38.211, clause 7.4.1.5.3).
freqBand, e.g. wideband or partial band CSI-RS, (see TS 38.214, clause 5.2.2.3.1).
Note: for more details on the above parameters, refer to IE CSI-RS-ResourceMapping in TS 38.331.
CSI-ResourcePeriodicityAndOffset, i.e. a periodicity and a corresponding offset for periodic and semi-persistent CSI resources.
Numerology of NR CSI-RS, including SCS and cyclic prefix (CP).
NR Common RB 0 or Physical RB 0 location, e.g. frequency location of the subcarrier 0 of Common RB 0 or Physical RB 0 in the NR carrier.

The 6G TRP may indicate one or multiple 5G NR CSI-RS resources to the 6G UE for the rate matching (and/or puncturing).

In Example 3, rate matching or puncturing is being performed to exclude the resources on which a CSI-RS is transmitted in 5G NR. The example assumes the communication between the 6G TRP and the 6G UE is downlink, which means the 6G TRP excludes transmitting, in the downlink, on the CSI-RS resources (via rate matching and/or puncturing), and the 6G UE receives and decodes the communication on the configured resources excluding the CSI-RS resources. However, more generally, the communication between the 6G UE and the 6G TRP could involve uplink communication, e.g. if the 6G UE and 6G TRP both support full duplex.

Example 4: The first time-frequency resources correspond to the time-frequency location of a 5G NR CORESET configuration in the shared spectrum. In the example, the apparatus 372 is a 6G UE, i.e. a UE that is communicating on 6G RAT. In the example, the device 352 is a 6G TRP, i.e. a TRP that can communicate with the 6G UE on 6G RAT. In the example, the first frequency band 402 is a 5G NR carrier and the second frequency band 404 is a 6G carrier.

The indication transmitted in step 452 and received in step 454 of FIG. 12 provides an indication that allows for the 6G UE to determine the time-frequency location of these first time-frequency resources (i.e. the time-frequency location of a 5G NR CORESET). The 6G UE may then rate match and/or puncture to exclude communicating on any REs (and/or RBs) occupied by a 5G NR CORESET.

The 6G TRP may indicate the 5G NR carrier information in the shared spectrum to the 6G UE, including the center frequency of the 5G NR carrier, the 5G NR carrier bandwidth, and/or the center of the subcarrier 0 of a common resource block or a PRB, and/or the frame timing (e.g. boundary of a frame/subframe/slot). This indication may be needed if the time-frequency location of the 5G NR CORESET is based on the 5G NR carrier information.

The 6G TRP may indicate the REs (or symbols and RBs) occupied by the 5G NR CORESET to the 6G UE, so that the 6G UE can rate match around and/or puncture these REs (or symbols and RBs). To indicate the mapping of a CSI-RS resource in the time and frequency domain, one, some or all of the following information may be indicated (where the exact information indicated is dependent upon the implementation):
frequencyDomainResources, i.e. frequency domain resources for the CORESET. E.g. a bitmap is used, each bit corresponds a group of 6 RBs.
Duration, e.g. contiguous time duration of the CORESET in number of symbols. The 6G UE may assume that a NR CORESET starts from the first symbol of a NR slot.
Note: for more details on the above parameters, refer to IE ControlResourceSet in TS 38.331.
Numerology of NR CORESET, including SCS and CP.
NR Common RB 0 or Physical RB 0 location, e.g. frequency location of the subcarrier 0 of Common RB 0 or Physical RB 0 in the NR carrier.

The 6G TRP may indicate one or multiple 5G NR CORESET resources to the 6G UE for the rate matching (and/or puncturing).

In Example 4, rate matching or puncturing is being performed to exclude the resources on which a CORESET is configured in 5G NR. The example assumes the communication between the 6G TRP and the 6G UE is downlink, which means the 6G TRP excludes transmitting, in the downlink, on the CORESET resources (via rate matching and/or puncturing), and the 6G UE receives and decodes the communication on the configured resources excluding the CORESET resources. However, more generally, the communication between the 6G UE and the 6G TRP could involve uplink communication, e.g. if the 6G UE and 6G TRP both support full duplex.

### EXAMPLE 5

The first time-frequency resources correspond to the time-frequency location of a 5G NR sounding reference signal (SRS) configuration in the shared spectrum. In the example, the apparatus 372 is a 6G UE, i.e. a UE that is communicating on 6G RAT. In the example, the device 352 is a 6G TRP, i.e. a TRP that can communicate with the 6G UE on 6G RAT. In the example, the first frequency band 402 is a 5G NR carrier and the second frequency band 404 is a 6G carrier.

The indication transmitted in step 452 and received in step 454 of FIG. 12 provides an indication that allows for the 6G UE to determine the time-frequency location of these first time-frequency resources (i.e. the time-frequency location of a 5G NR SRS). The 6G UE may then rate match and/or puncture to exclude communicating on any REs (and/or RBs) occupied by a 5G NR SRS.

The 6G TRP may indicate the 5G NR carrier information in the shared spectrum to the 6G UE, including the center frequency of the 5G NR carrier, the 5G NR carrier bandwidth, and/or the center of the subcarrier 0 of a common resource block or a PRB, and/or the frame timing (e.g. boundary of a frame/subframe/slot). This indication may be needed if the time-frequency location of the 5G NR SRS is based on the 5G NR carrier information.

The 6G TRP may indicate the REs occupied by the 5G NR SRS to the 6G UE, so that the 6G UE can rate match around and/or puncture these REs. To indicate the RE mapping of an SRS resource in the time and frequency domain, one, some or all of the following information may be indicated (where the exact information indicated is dependent upon the implementation):
nrofSRS-Ports, i.e. number of SRS ports.
transmissionComb, e.g. Comb value (2 or 4 or 8) and comb offset (see TS 38.214, clause 6.2.1).
resourceMapping, including startPosition, nrofSymbols, repetitionFactor. E.g. OFDM symbol location of the SRS resource within a slot including nrofSymbols (number of OFDM symbols), startPosition (value 0 refers to the last symbol, value 1 refers to the second last symbol, and so on) and repetitionFactor (see TS 38.214, clause 6.2.1 and TS 38.211, clause 6.4.1.4).
freqDomainPosition, i.e. frequency domain locations for SRS.
periodicityAndOffset, i.e. periodicity and slot offset for this SRS resource.
Note: for more details on the above parameters refer to IE SRS-Resource, SRS-ResourceSet in TS 38.331.
Numerology of NR SRS, including SCS and CP.
NR Common RB 0 or Physical RB 0 location, e.g. frequency location of the subcarrier 0 of Common RB 0 or Physical RB 0 in the NR carrier.

The 6G TRP may indicate one or multiple 5G NR SRS resources to the 6G UE for the rate matching (and/or puncturing).

In Example 5, rate matching or puncturing is being performed to exclude the resources on which an SRS is configured in 5G NR. The example assumes the communication between the 6G TRP and the 6G UE is uplink, which means the 6G UE excludes transmitting, in the uplink, on the SRS resources (via rate matching and/or puncturing), and the 6G TRP receives and decodes the communication on the configured resources excluding the SRS resources. However, more generally, the communication between the 6G UE and the 6G TRP could involve downlink communication, e.g. if the 6G UE and 6G TRP both support full duplex.

### EXAMPLE 6

The first time-frequency resources correspond to the time-frequency location of a 5G NR physical random access channel (PRACH) configuration in the shared spectrum. In the example, the apparatus 372 is a 6G UE, i.e. a UE that is communicating on 6G RAT. In the example, the device 352 is a 6G TRP, i.e. a TRP that can communicate with the 6G UE on 6G RAT. In the example, the first frequency band 402 is a 5G NR carrier and the second frequency band 404 is a 6G carrier.

The indication transmitted in step 452 and received in step 454 of FIG. 12 provides an indication that allows for the 6G UE to determine the time-frequency location of these first time-frequency resources (i.e. the time-frequency location of a 5G NR PRACH). The 6G UE may then rate match and/or puncture to exclude communicating on any REs (and/or RBs) occupied by a 5G NR PRACH.

The 6G TRP may indicate the 5G NR carrier information in the shared spectrum to the 6G UE, including the center frequency of the 5G NR carrier, the 5G NR carrier bandwidth, and/or the center of the subcarrier 0 of a common resource block or a PRB, and/or the frame timing (e.g. boundary of a frame/subframe/slot). This indication may be needed if the time-frequency location of the 5G NR PRACH is based on the 5G NR carrier information.

The 6G TRP may indicate the REs occupied by the 5G NR PRACH to the 6G UE, so that the 6G UE can rate match around and/or puncture these REs. To indicate the RE mapping of a PRACH resource in the time and frequency domain, one, some or all of the following information may be indicated (where the exact information indicated is dependent upon the implementation):
prach-ConfigurationIndex, i.e. PRACH configuration index. See, for example TS 38.211, clause 6.3.3.2. The index indicates a row in the PRACH configuration table, e.g. Table 6.3.3.2-2. According to the indicated row in the table, the PRACH time-domain location is known by the 6G UE.
msg1-FrequencyStart, e.g. offset of lowest PRACH transmission occasion in the frequency domain with respect to NR PRB 0. See, for example, TS 38.211, clause 6.3.3.2.
msg1-FDM, e.g. the number of PRACH transmission occasions FDMed in one time instance. See, for example, TS 38.211, clause 6.3.3.2.
number of RBs expressed with a numerology. The numerology and number of RBs may be determined according to the length and SCS for PRACH as in Table 6.3.3.2-1 in TS 38.211, where the length and SCS for PRACH is determined according to the above prach-ConfigurationIndex.
Note: for more details on the above parameters refer to IE RACH-ConfigGeneric in TS 38.331.
NR Common RB 0 or Physical RB 0 location, e.g. frequency location of the subcarrier 0 of Common RB 0 or Physical RB 0 in the NR carrier.

The 6G TRP may indicate one or multiple 5G NR PRACH resources to the 6G UE for the rate matching (and/or puncturing).

In Example 6, rate matching or puncturing is being performed to exclude the resources on which a PRACH is configured in 5G NR. The example assumes the communication between the 6G TRP and the 6G UE is uplink, which means the 6G UE excludes transmitting, in the uplink, on the PRACH resources (via rate matching and/or puncturing), and the 6G TRP receives and decodes the communication on the configured resources excluding the PRACH resources. However, more generally, the communication between the 6G UE and the 6G TRP could involve downlink communication, e.g. if the 6G UE and 6G TRP both support full duplex.

### EXAMPLE 7

The first time-frequency resources correspond to the time-frequency location of a 5G NR physical uplink control channel (PUCCH) configuration in the shared spectrum. In the example, the apparatus 372 is a 6G UE, i.e. a UE that is communicating on 6G RAT. In the example, the device 352 is a 6G TRP, i.e. a TRP that can communicate with the 6G UE on 6G RAT. In the example, the first frequency band 402 is a 5G NR carrier and the second frequency band 404 is a 6G carrier.

The indication transmitted in step 452 and received in step 454 of FIG. 12 provides an indication that allows for the 6G UE to determine the time-frequency location of these first time-frequency resources (i.e. the time-frequency location of a 5G NR PUCCH). The 6G UE may then rate match and/or puncture to exclude communicating on any REs (and/or RBs) occupied by a 5G NR PUCCH.

The time-frequency location of the 5G NR PUCCH may be indicated directly or indirectly, depending upon the implementation.

In Example 7, rate matching or puncturing is performed to exclude the resources on which a PUCCH is configured in 5G NR. The example assumes the communication between the 6G TRP and the 6G UE is uplink, which means the 6G UE excludes transmitting, in the uplink, on the PUCCH resources (via rate matching and/or puncturing), and the 6G TRP receives and decodes the communication on the configured resources excluding the PUCCH resources. However, more generally, the communication between the 6G UE and the 6G TRP could involve downlink communication, e.g. if the 6G UE and 6G TRP both support full duplex.

Examples 1 to 7 above are described in the context of 5G NR and 6G. The 6G TRP indicates, to the 6G UE, the time-frequency location of a 5G NR signal or channel configuration, so that the 6G UE can rate match and/or puncture around these time-frequency resources, which can result in improved spectrum sharing efficiency in the manner described herein.

The examples above do not need to be limited to the specific RATs 5G NR and 6G. As an example, in some embodiments of the method of FIG. 12, the first time-frequency resources correspond to the time-frequency location of one or more SSBs of the first RAT. The indication transmitted in step 452 and received in step 454 may include: (i) a time-domain indication that indicates a time location of at least one SSB, and/or (ii) a frequency domain indication that indicates a frequency location of the at least one SSB. The time-domain indication may include an indication of at least one of: a frame timing of the first RAT; a SCS of the at least one SSB; a pre-defined candidate time-domain location of the at least one SSB for each SCS; a periodicity of the at least one SSB; or a transmitted SS/PBCH block on the first RAT. The frequency-domain indication may include an indication of at least one of: a center of the first frequency band; a bandwidth of the first frequency band; an SSB subcarrier offset; a lowest RB location of an SSB after the SSB subcarrier offset is resolved; or a lowest subcarrier location of an SSB after the SSB subcarrier offset is resolved. This is based on Example 1 above, but unlike Example 1 it need not be limited to the first RAT being 5G NR or the second RAT being 6G.

### Dynamic Release of Prohibited Resources

In the method of FIG. 12, the wireless communication on the second RAT on the second frequency band 404 (in step 456) excludes communicating on the first time-frequency resources, because these first time-frequency resources are associated with a wireless transmission on the first RAT on the first frequency band 402. With reference to FIG. 13, on the overlapped time-frequency resources 406 (the shared spectrum), there are time-frequency resources 408 reserved for wireless communication on the first RAT on the first frequency band 402. These time-frequency resources 408 are referred to as the prohibited resources 408. The first time-frequency resources are the prohibited resources 408 that are within the RBs configured for wireless communication on the second RAT on the second frequency band 404.

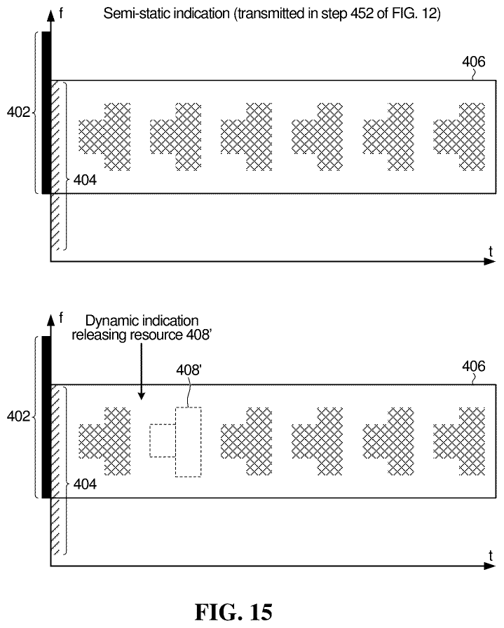

In some embodiments, the prohibited resources 408 are indicated to the apparatus 372 on a semi-static basis, e.g. using higher layer signaling. That is, the indication transmitted in step 452 (and received in step 454) may be a semi-static indication. The indication may be any of the indications described in the examples above (e.g. in Examples 1 to 7 above). Then, during operation, if it turns out that at some time instances a prohibited resource is actually available, i.e. it is determined that the prohibited resource will not be used for a wireless transmission on the first RAT on the first frequency band 404, then the device 352 may indicate this to the apparatus 372, e.g. in DCI or in a MAC-CE. For example, FIG. 15 illustrates a semi-static indication (top of figure), followed by a dynamic release of resource 408′ (bottom of figure). The apparatus 372 does not need to exclude communication on the released resource 408′. That is, if the apparatus 372 is configured to perform a wireless communication on the second RAT on the second frequency band, and that wireless communication is configured on resources that include resource 408′, then the apparatus 372 can communicate on resource 408′.

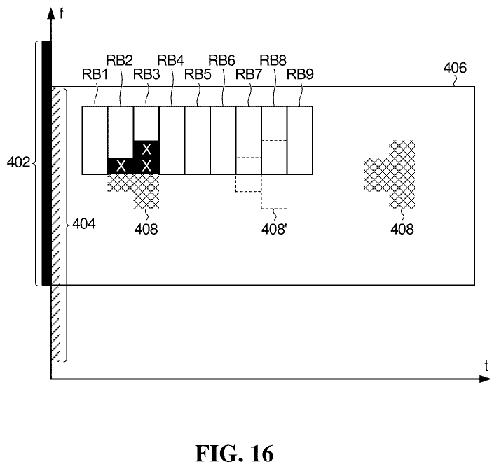

With reference to the method of FIG. 12, in some embodiments the indication transmitted in step 452 and received in 454 is a first indication. The first indication may be received in semi-static signaling. The first indication also indicates that third time-frequency resources are also associated with the wireless transmissions on the first RAT. The third time-frequency resources are a subset of the second time-frequency resources and are different from the first time-frequency resources. Then, prior to the wirelessly communicating (in step 456) the method further includes receiving a second indication. The second indication may be received in DCI (dynamic), or alternatively in a MAC-CE. The second indication indicates that the third time-frequency resources are not being used for wireless transmission on the first RAT. The wirelessly communicating on the second time-frequency resources includes communicating on the third time-frequency resources. An example is illustrated in FIG. 16. The wireless communication in step 456 is configured on nine RBs. RBs 2, 3, 7, and 8 include REs that were indicated (in step 452) as being associated with wireless transmissions on the first RAT on the first frequency band 402 (i.e. prohibited REs). However, a second indication is received indicating that resources 408′ are not being used for wireless transmission on the first RAT. Therefore, the wireless communication on the 9 RBs excludes transmitting on the prohibited REs in RBs 2 and 3, but includes communicating on all the REs of RBs 7 and 8. The first time-frequency resources are the REs in RBs 2 and 3 that are shown by black boxes with X's, the second time-frequency resources are all of the time-frequency resources in the nine RBs, excluding the first time-frequency resources, and the third time-frequency resources are the REs in 408′ that are in RBs 7 and 8. Communication occurs on those REs.

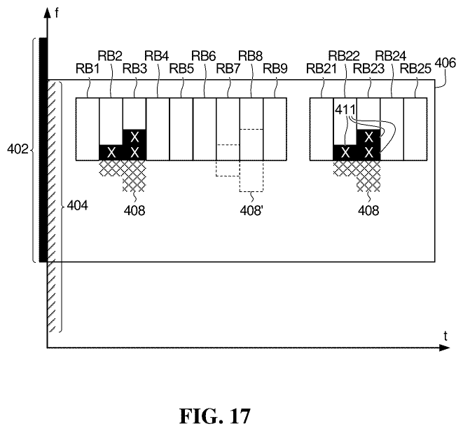

In some embodiments of the method of FIG. 12, the wireless communication in step 456 is a first wireless communication on the second RAT. The method of FIG. 12 may further include receiving information configuring a second subsequent wireless communication on the second RAT. The second subsequent wireless communication is configured on resources that include a subset of time-frequency resources that were also indicated, in the first indication, as being associated with the wireless transmissions on the first RAT, e.g. the subset of time-frequency resources are part of prohibited resources 408. The method may further include performing the subsequent wireless communication, but excluding communicating on that subset of time-frequency resources. For example, continuing the example in FIG. 16, and with reference to FIG. 17, there may a first wireless communication on the second RAT, which is configured on RBs 1 to 9, and a subsequent second wireless communication on the second RAT, which is configured on RBs 21 to 25. The subsequent second wireless communication is configured on resources that include a subset of time-frequency resources 411 that were indicated in step 452/454 as being associated with the wireless transmissions on the first RAT (i.e. part of prohibited resources 408). The subsequent second wireless communication on RBs 21 to 25 therefore excludes communicating on time-frequency resources 411, e.g. by rate matching around those resources or puncturing.

In some embodiments, when the second indication is received indicating that the third time-frequency resources are not being used for wireless transmission on the first RAT, the apparatus 372 may assume that all subsequent prohibited time-frequency resources are also not being used for wireless transmission on the first RAT, and the apparatus 372 may communicate on those resources until another indication is received indicating that the resources are again being used for wireless transmission on the first RAT. For example, in the example in FIG. 17, prior to performing the subsequent wireless communication (on RBs 21 to 25), the method may include receiving a further indication indicating that it is prohibited for the apparatus 372 to perform the subsequent wireless communication on the subset of time-frequency resources 411. Otherwise, if the further indication was not received, the resources 411 would be treated like resources 408′, i.e. available for the apparatus 372 to use. This further indication may be received in DCI (dynamically) or in a MAC-CE.

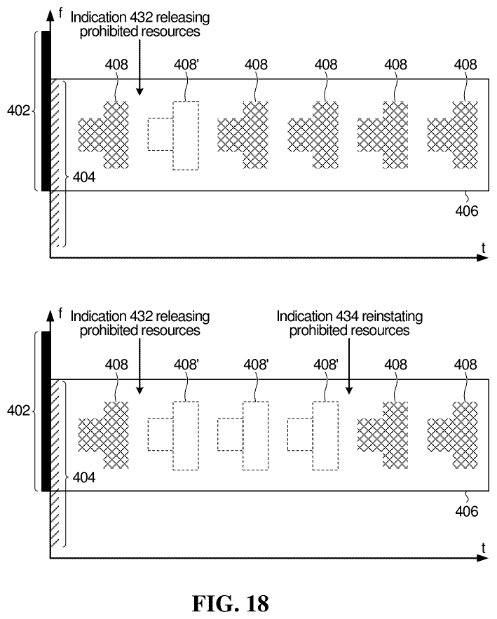

The two options for releasing prohibited resources are illustrated in FIG. 18. The device 352 first semi-statically indicates (e.g. at step 452 of FIG. 12) prohibited resources 408, including 408′. These prohibited resources may be referred to as “candidate rate matching (or puncturing) resources”. The prohibited resources may be, for example, resources that may be used by a 5G NR SSB, 5G NR CSI-RS, 5G NR CORESET, 5G NR SRS, 5G NR PUCCH, and/or 5G NR PRACH. The semi-static indication may be sent in a system information block (SIB) or in RRC signaling, or in a MAC CE.

Subsequently, during operation, the device 352 releases a prohibited resource. Releasing a prohibited resource may also be referred to as deactivating the resource. The released prohibited resource is identified using reference character 408′. When released, it means that the resource is not being used by the first RAT (e.g. by a 5G NR transmission), and so the apparatus 372 and device 352 may communicate on the resource 408′ on the second RAT (e.g. a 6G transmission). The release may be dynamic, e.g. in DCI. Alternatively, it may be semi-static also, e.g. in a MAC CE. Dynamic release allows for dynamic spectrum sharing for situations in which it turns out the prohibited resource reserved for a transmission on the first RAT (e.g. a 5G transmission) is not actually going to be used by the first RAT.

In Option 1 of FIG. 18, when the release indication 432 is received by the apparatus 372 from the device 352, the immediately proceeding prohibited resource 408′ is released, and it is used for the apparatus 372 and device 352 to wirelessly communicate on the second RAT. The subsequent prohibited resources are not released and rate matching and/or puncturing is required. Option 1 may be referred to as a “short release”. In Option 2 of FIG. 18, when the release indication 432 is received by the apparatus 372 from the device 352, all proceeding prohibited resources 408′ are released (and used for the apparatus 372 and device 352 to wirelessly communicate on the second RAT), until a further indication 434 is received reinstating the prohibited resources, i.e. indicating again that it is necessary to rate match around and/or puncture the prohibited resources. The further indication 434 may be sent in DCI or in a MAC CE.

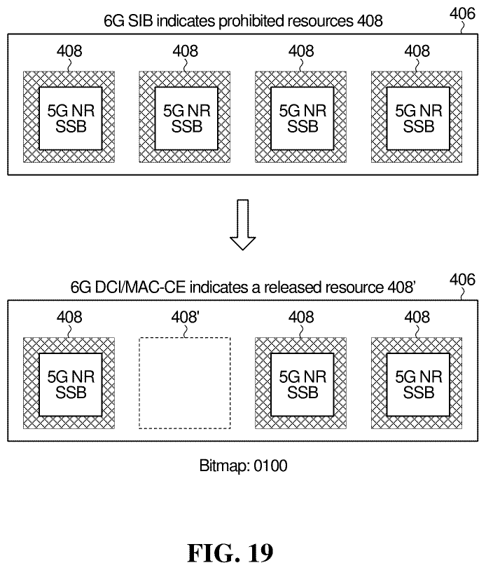

The signal design for a release indication (e.g. indication 432) may be as follows. In one option a bitmap is used for the release indication, where each bit corresponds to a respective instance of a prohibited resource. An example of a bitmap release indication is illustrated in FIG. 19 for the situation in which the first RAT is 5G NR RAT, the second RAT is 6G, and the prohibited resources 408 are time-frequency locations reserved for transmission of a 5G NR SSB. The 6G TRP indicates four prohibited resources 408, which are candidates for transmission of a 5G NR SSB. The indication is transmitted in a SIB, but this is only an example (e.g. RRC or MAC CE may be used instead). Then, during operation, a release indication in the form of a 4-bit bitmap is sent indicating that resources 408′ is unoccupied, because actually only three 5G NR SSBs are to be transmitted. The bitmap in the example is 0100, where the 1 indicates that the second SSB location is released. The bitmap may be sent, for example, in DCI or MAC CE. In an alternative option, instead of a bitmap, each instance of a prohibited resource may have a respective resource ID, and the release indication may indicate the ID of each resource being released.

The embodiments explained above in relation to FIGS. 15 to 19 may be beneficial in situations in which a pattern of resources 408 reserved for communications on the first RAT are indicated to the apparatus 372 in advance, and then exceptions (e.g. resources 408′) can be signaled to the apparatus 372 during operation. This may save signaling overhead compared to indicating the resources 408 more dynamically on an ongoing basis during operation. In some implementations in the context of 5G NR RAT and 6G RAT, the 6G UEs may receive a semi-static configuration of candidate prohibited resources, with dynamic signaling to release some of those resources to support dynamic and flexible spectrum sharing between 5G NR and 6G.

### Multiple SSB Patterns in the Shared Spectrum

In some embodiments, the second RAT may be associated with multiple synchronization signal block (SSB) patterns that may be transmitted on the second frequency band 404 on the overlapped resources 406. In the examples below, the second RAT is associated with a first SSB time-frequency location pattern and a second SSB time-frequency location pattern for transmission of SSBs on the second RAT on the second frequency band. However, in general there may be more than two different patterns. In some embodiments, if there are multiple SSB patterns, the apparatus 372 is sent/receives an indication of which pattern is being used. For example, if there are two SSB patterns, the apparatus 372 is sent/receives an indication of whether the first SSB time-frequency location pattern or the second SSB time-frequency location pattern is being used.

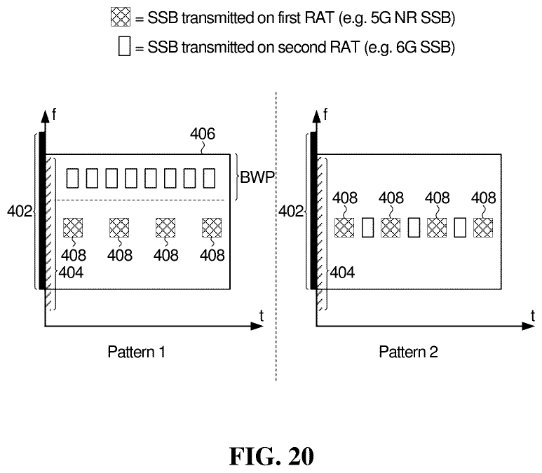

FIG. 20 illustrates a first SSB time-frequency location pattern and a second SSB time-frequency location pattern, according to one embodiment. In the first SSB time-frequency location pattern (“Pattern 1”), the SSBs transmitted on the second RAT on the second frequency band 404 (e.g. the 6G SSBs) are limited to a BWP on the overlapped time-frequency resources 406, where that BWP does not overlap in the frequency domain with SSBs 408 (e.g. 5G NR SSBs) transmitted on the first RAT on the first frequency band 402. That is, the first SSB time-frequency location pattern (“Pattern 1”) includes SSBs transmitted on the second RAT on the second frequency band 404 on different frequency resources than SSBs transmitted on the first RAT on the first frequency band 402.

In the second SSB time-frequency location pattern (“Pattern 2”), the SSBs transmitted on the second RAT on the second frequency band 404 (e.g. the 6G SSBs) at least partially overlap in the frequency domain with SSBs 408 (e.g. 5G NR SSBs) transmitted on the first RAT on the first frequency band 402. The SSBs of the second RAT are multiplexed in time with the SSBs of the first RAT, e.g. alternating like shown in FIG. 20, so that there is not interference. That is, the second SSB time-frequency location pattern (“Pattern 2”) includes SSBs transmitted on the second RAT on the second frequency band 404 on frequency resources that at least partially overlap with the frequency resources of SSBs transmitted on the first RAT on the first frequency band 402, but multiplexed in time. Because of the multiplexing, for a given duration of time, more SSBs of the second RAT are transmitted in Pattern 1 than in Pattern 2.

A more specific example of Pattern 1 and Pattern 2 is described below for the situation in which the first RAT is 5G NR and the second RAT is 6G, such that Pattern 1 and Pattern 2 relate to the pattern of transmission of 6G SSBs in the shared spectrum (i.e. in the overlapped resources 406):
6G SSB Pattern 1: Within a time burst, e.g. 5 ms, the number of candidate SSBs is M1, where M1 is a relatively large number. This is because 6G has more SSB beams due to the increased number of antennas. Pattern 1 can be used when the 6G SSB is not overlapped with the 5G SSB in the frequency-domain, so all of the time burst can be used to transmit the 6G SSBs.
6G SSB Pattern 2: Within a time burst, e.g. 5 ms, the number of candidate SSBs is M2, M2<M1. Pattern 2 can be used when the 6G SSB is overlapped with the 5G SSB in the frequency-domain, so only part of the time burst can be used to transmit the 6G SSBs, because the other part of the time burst is being used for transmission of the 5G SSBs.

In general, the 5G and 6G RATs may have different time burst lengths for their SSBs, although they could be the same length, e.g. 5 ms burst for both 5G and 6G.

When the traffic load for 6G is light, e.g. a small number of 6G UEs in the early deployment of 6G, the 6G carrier or 6G BWP may occupy a small bandwidth in the shared spectrum, e.g. Pattern 1 in which there is FDM coexistence between 5G NR and 6G, so that there is no overlap in the frequency domain between the 6G SSBs and the 5G NR SSBs. SSB Pattern 1 may be utilized for the 6G carrier. When the traffic load for 6G is heavy, the 6G carrier or 6G BWP instead occupies a large bandwidth in the shared spectrum, e.g. the whole carrier bandwidth of the shared spectrum. To achieve the best synchronization performance for the 6G UEs, the 6G SSB may be located on the center of 6G BWP, which is similar to the 5G SSB deployment. This means Pattern 2, i.e. the 6G SSBs are overlapped with the 5G NR SSBs in the frequency domain. SSB Pattern 2 is utilized for the 6G carrier. The smaller BW for 6G SSB transmission (i.e. SSB Pattern 1) is beneficial for 6G TRP and 6G UE power savings, but when 6G UE traffic load is heavy, then SSB Pattern 2 is used because heavy traffic load means the smaller bandwidth of SSB Pattern 1 cannot support too many 6G UEs.

The 6G SSB pattern (e.g. Pattern 1 or Pattern 2) and/or the 6G SSB location may be dynamically updated by the 6G TRP, e.g. according to the traffic load of 6G UEs being served by the 6G TRP. For a UE in a power saving mode, e.g. IDLE state, the SSB pattern and/or the location may be changed, so the SSB pattern and/or the location may be indicated to the UE when the UE is wakeup, e.g. by paging signal.

One example is as follows. When a UE is in power saving mode, e.g. IDLE state, the UE stay in a small-sized BWP. For example, the BW of the BWP is much smaller than the BW for transmission of the 6G SSB. The UE then uses a reference signal (RS) (e.g. a Tracking RS or CSI-RS) for coarse synchronization and automatic gain control (AGC) setting. Upon receiving paging, the paging indicates one, some, or all of the following information (with the exact information indicated dependent upon the implementation):
6G SSB pattern, e.g. Pattern 1 or Pattern 2.
6G SSB location, e.g. time location and/or frequency location of the 6G SSB. The time location of the SSB may be indicated by indicating the symbols and/or periodicity of the 6G SSB. The frequency location of the SSB may be indicated by: (i) indicating the Global Synchronization Channel Number (GSCN); or (ii) by indicating an offset from a frequency reference point, where the frequency reference point is predefined or configured (according to the offset, the UE can know the lowest RB or highest RB or center of the 6G SSB); or (iii) some candidate 6G SSB locations in the frequency domain may be pre-defined or configured, e.g. a candidate location has an index, and paging may indicate which candidate location is for 6G SSB transmission, e.g. indicate the location index.
Active BWP, e.g. the paging indicates a BWP (switch-to BWP), and the UE is switched to that BWP after receiving the paging.

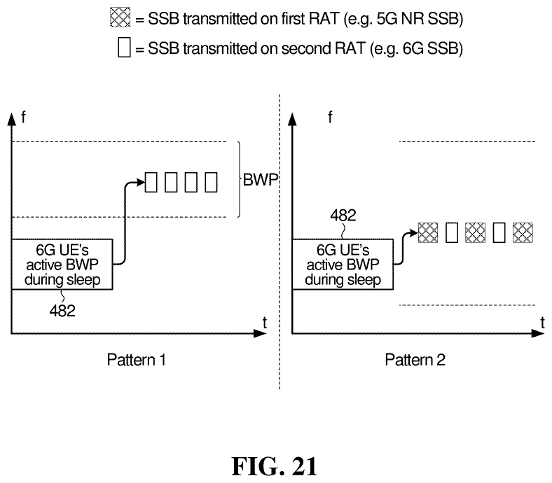

FIG. 21 illustrates an example of the 6G UE's active BWP during sleep mode in relation to the two SSB Patterns. In Pattern 1, the 6G UE has an active BWP 482 during sleep mode, and paging indicates: the 6G SSB location (e.g. by indicating GSCN), the 6G SSB pattern, and the switch-to-BWP. The active BWP 482 may be much smaller than the 6G SSB, and the 6G UE may use a tracking RS or CSI-RS for coarse synchronization and AGC setting. The 6G UE active BWP 482 is also illustrated in the context of Pattern 2.

By having the paging indicate the 6G SSB location, and active BWP location, this reduces the 6G UEs blind search effort because the UE does not have to blindly decode the location of the SSB. This achieves 6G UE power savings compared to blind decoding.

The examples above are specific to 6G and 5G NR RATs. In general, there may be multiple SSB time-frequency location patterns for transmission of SSBs on the second RAT on the shared spectrum, where the second RAT is not necessarily 6G. The multiple SSB time-frequency location patterns may include a first time-frequency location pattern (e.g. Pattern 1 of FIG. 20) and a second time-frequency location pattern (e.g. Pattern 2 of FIG. 20). The apparatus 372 may receive, from the device 352, an indication of whether the first SSB time-frequency location pattern or the second SSB time-frequency location pattern is being used. The indication may additionally or instead indicate at least one of: a frequency location of an SSB, a time location of an SSB, a carrier on which an SSB is located, or a BWP on which an SSB is located, where the SSB is an SSB transmitted on the second RAT. The indication may be received in a paging message. The apparatus 372 may use a reference signal for coarse synchronization in order to receive the paging message.

Assuming the first and second RATs described herein are 5G NR RAT and 6G RAT, respectively, by implementing embodiments herein, the following may be achieved in some embodiments. It may be possible to support dynamic spectrum sharing between 5G NR and 6G, e.g. support a 6G carrier sharing the same frequency band used by a 5G carrier, especially to support RE level dynamic spectrum sharing to use all unused available REs by 5G UEs. The support of 5G-6G spectrum sharing may allow a network to deploy 5G and 6G in the same carriers and bands, i.e. it may enable both 5G and 6G to be simultaneously deployed and share resources in a carrier. In the early stage of 6G, dynamic spectrum sharing between 5G and 6G has advantages on smooth migration to 6G. Some embodiments herein provide solutions to support 5G NR/6G dynamic spectrum sharing, including addressing problems such as: how to achieve RE-level sharing with minimum indication overhead, and for RB-symbol level dynamic spectrum sharing, how to reduce the indication overhead (e.g. by two bitmap, one bitmap for RBs, one bitmap for symbols)? In some embodiments, there is provided 5G NR/6G Dynamic Spectrum Sharing, e.g. where a 6G TRP indicates to a 6G UE the configuration of a 5G NR signal or channel configuration (e.g. the time-frequency resources that are prohibited), so that the 6G UE knows which REs, or which RBs-symbols are occupied by 5G UE, i.e. not available for 6G UE, which allows for the 6G UE to rate match and/or puncture around these REs (or RBs-symbols) to achieve and/or improve spectrum sharing efficiency.

In some embodiments, (e.g. FIG. 13), there may be RE-level spectrum sharing (or named as RE-level Rate Matching/Puncturing), in which some REs of the 5G spectrum are declared not available (prohibited) for 6G physical channel (e.g. 6G PDSCH, PUSCH) or physical signal (6G reference signal), and the 6G physical channel rate matches around those REs, or punctures those REs. In some embodiments, (e.g. FIG. 14), there may be RB-symbol level spectrum sharing (or named as RB-symbol level Rate Matching/Puncturing), in which N RBs in M symbols may be declared not available for 6G physical channel or physical signal, where M and N are integer. The spectrum sharing methods are applicable for when there is any type of overlap of the frequency bands, which is why the variations shown in FIG. 8 are provided. Scenarios may include: (1) same frequency location for 5G carrier and 6G carrier; (2) partial frequency overlapping between 5G carrier and 6G carrier; and (3) multiple 5G carriers are frequency overlapped with 6G carrier. The spectrum sharing method described herein is applicable for all the 3 cases (1) to (3), supporting semi-static/dynamic frequency division multiple FDM, TDM, or FDM+TDM sharing between 5G and 6G.

In some embodiments, there is provided semi-static rate matching resource indication, plus dynamic resource release. For example, a 6G SIB may indicate candidate prohibited (rate matched/punctured) resources, and MAC-CE or DCI indicates whether a candidate prohibited resource is available for a 6G UE (i.e. prohibited resource release). In some embodiments, there is provided a UE wakeup procedure in the shared carrier, e.g. the two SSB patterns discussed above, where in some embodiments paging indicates: 6G SSB location, 6G SSB pattern, and/or switch-to BWP.

In some embodiments herein there is provided RE-level dynamic spectrum sharing between 5G NR and 6G, where the 6G TRP indicates time-frequency resources of the 5G NR SSBs to a 6G UE. The indication may be a time-domain indication and a frequency domain indication. For the time-domain indication, it may indicate timing reference point (NR half-frame boundary), SCS of NR SSB, Periodicity of NR SSB burst set, and/or Actually Transmitted NR SS/PBCH Block. For the frequency-domain indication, it may indicate GSCN (Global Synchronization Channel Number) of the 5G NR SSB, or indicate 5G NR carrier information, e.g.: Center of 5G NR carrier, 5G NR carrier BW, K_{ssb} (offset between the edge of the SS/PBCH RBs and the edge of the data RBs), and/or Lowest RB index of SSB after k_{ssb} is resolved. 6G TRP may indicate the existence of a 5G NR CORESET0 associated to an SSB, e.g. indicate time-frequency location of CORESET0 for SIB1: SCS of CORESET0, ControlResourceSetZero (8 bit). The 6G TRP may indicate 5G NR CSI-RS resources to 6G UE: Periodicity and Offset, frequencyDomainAllocation, nrofPorts, firstOFDMSymbolInTime Domain, cdm-Type, and/or density.

In some embodiments herein, there is provided semi-static indication of prohibited resources, plus dynamic release (de-activation) of certain prohibited resources. The 6G SIB/RRC may indicate semi-static prohibited resources. The 6G MAC-CE/DCI may indicate that some semi-static prohibited resources are released. In some embodiments, there is provided a UE wakeup procedure in a shared carrier. There may be multiple 6G SSB patterns, which may depend on whether 6G SSB and 5G NR SSB are overlapped in frequency. Paging may indicate: 6G SSB location (e.g. GSCN), 6G SSB pattern, and/or Switch-to BWP.

### Some Specific Examples

The following are some specific examples commensurate with embodiments discussed herein. The following is not meant to be limiting.

In current networks, 5G NR (New Radio) carrier could share the same spectrum used by LTE carrier. BS could dynamically allocate time and frequency resources, which are not used by LTE UEs, to NR UEs to achieve high spectrum efficiency.

In future 6G deployment, 5G Networks and 5G UEs are likely to be around for the initial deployment of the 6G network. Therefore, it is important to support dynamic spectrum sharing between 5G NR and 6G, e.g. support 6G carrier sharing the same frequency band used by 5G carrier, especially to support RE level dynamic spectrum sharing to use all unused available REs by 5G UEs.

In some embodiments below, we provide schemes to support 5G-6G spectrum sharing, which allows a network to deploy 5G and 6G in the same carriers and bands, i.e. enables both 5G and 6G to be simultaneously deployed and shared resources in a carrier. In the early stage of 6G, dynamic spectrum sharing between 5G and 6G has advantages of smooth migration to 6G.

A problem and objective is to support NR-6G dynamic spectrum sharing: How to achieve RE-level sharing with minimum indication overhead? For RB-symbol level DSS, how to reduce the indication overhead as compared to NR indication scheme (by two bitmap, one bitmap for RBs, one bitmap for symbols)?

An overview is as follows: (1) NR-6G Dynamic Spectrum Sharing: 6G BS indicates 6G UE the configuration of 5G NR signal or channel configuration, so 6G UE could rate match around these REs to improve spectrum sharing efficiency. (2) Semi-static Rate Matching resource indication+dynamic RM resource release: 6G SIB indicates candidate RM resources, MAC-CE/DCI indicates whether a candidate RM resource is available for 6G UE (i.e. RM resource release). (3) UE wakeup procedure in the shared carrier: Paging indicates: 6G SSB location, 6G SSB pattern, switch-to BWP.

### Embodiment 1

Some terms definition:

RE-level spectrum sharing (or named as RE-level Rate Matching): some Resource Elements (REs) are declared not available for 6G physical channel (e.g. 6G PDSCH, PUSCH) or physical signal (6G reference signal). 6G physical channel rate matches around those REs, or punctures those REs.

RB-symbol level spectrum sharing (or named as RB-symbol level Rate Matching): N RBs in M symbols are declared not available for 6G physical channel or physical signal, where M and N are integer.

These NR specifications are for reference: 3GPP TS 38.211 V17.3.0; 3GPP TS 38.212V17.3.0; 3GPP TS 38.213 V17.3.0; 3GPP TS 38.214 V17.3.0; 3GPP TS 38.331 V17.3.0

Scenarios: (1) Same frequency location for 5G carrier and 6G carrier; (2) Partial frequency overlapping between 5G carrier and 6G carrier; (3) multiple 5G carriers are frequency overlapped with 6G carrier. Note: our methods may be applicable for all the 3 cases, supporting semi-static/dynamic FDM, TDM, or FDM+TDM sharing between 5G and 6G. FIG. 8 illustrates examples of various frequency location scenarios, noting that it only shows the portions in time where there is frequency overlap.

6G BS indicates to 6G UE the configuration of 5G NR signal or channel configuration, so 6G UE knows which REs, or which RBs-symbols are occupied by 5G UE, i.e. not available for 6G UE. Therefore, 6G UE could rate match around those REs, RBs-symbols to achieve spectrum sharing.

(1) 6G BS indicates to 6G UE the NR SSB configuration in the shared spectrum: 6G BS indicates REs for NR SSB in the shared spectrum to 6G UE, so 6G UE could rate match around NR SSB, e.g. rate match the REs for NR SSB to avoid interference between 5G and 6G. There are some available unused REs in NR SSBs. The total number of available REs is non-negligible due to periodically SSB beam sweeping. 6G shall dynamically use these REs.

6G BS indicates the Time-domain location of NR SSB in the shared spectrum to 6G UE, the indication includes one or more of the following parameters:
Frame timing of the NR carrier
   The boundary of NR frame or half-frame
SCS (subcarrier spacing) of NR SSB
   Another option: the SCS is determined based on the band of the shared spectrum, according to the table Table 5.4.3.3-1 (Applicable SS raster entries per operating band) in 3GPP TS 38.101-1 V18.0.0, 6G UE could find the SS Block SCS in the shared spectrum band. If there are two available SCSs, 6G BS indicates which SCS is used by the NR carrier
Pre-defined candidate time-domain locations of NR SSB for each NR SSB SCS
   As shown in section 4.1 of 5G spec: 3GPP TS 38.213, for a half frame with SS/PBCH blocks, the first symbol indexes for candidate SS/PBCH blocks are determined according to the SCS of SS/PBCH blocks, more details could be found in TS 38.213.
Periodicity of NR SSB
   Periodicity of NR SSB burst set, E.g. 5 ms, 10 ms, 20 ms, 40 ms, 80 ms, 160 ms. If this parameter is not indicated to 6G UE, the 6G UE applies the value 5 ms.
Actually Transmitted NR SS/PBCH Block
   For a candidate time-domain location of NR SSB, the NR SSB may not be transmitted by 5G carrier.
      Option 1: A bitmap is used for indication of actual SS/PBCH block transmission, one bit corresponds to one candidate location of SSB.
      Option 2: Indication is in compressed form (e.g. in above 6 GHz case): ‘Group-bitmap (8 bits)+bitmap in Group (8 bits), 64 SSBs are in 8 groups, each group has 8 SSBs.

6G BS indicates the Frequency-domain location of NR SSB in the shared spectrum to 6G UE, the indication includes one or multiple following parameters.
Option 1: directly indicate NR SSB location
   Alternative 1 (“Alt-1”): indicate GSCN (Global Synchronization Channel Number) of NR SSB
      As shown in TS 38.101-1 v18.0.0, in NR, a global synchronization raster is defined for all frequencies. The frequency position of the SS block is defined as SSREF with corresponding number GSCN. The parameters defining the SSREF and GSCN for all the frequency ranges are in Table 5.4.3.1-1.
      GSCN identifies the position of resource element RE=#0 (subcarrier #0) of resource block RB #10 of the SS block. Therefore, by GSCN, 6G UE could find the exact frequency location of NR SSB

TABLE
GSCN parameters for the global frequency raster

| Frequency | SS Block frequency | | Range of |
|---|---|---|---|
| range | position SS_{REF} | GSCN | GSCN |
| 0-3000 | N * 1200 kHz + M * 50 kHz, | 3N + | 2-7498 |
| MHz | N = 1:2499, M ∈ {1, 3, 5} | (M − 3)/2 | |
| | (Note 1) | | |
| 3000-24250 | 3000 MHz + N * 1.44 MHz | 7499 + N | 7499-22255 |
| MHz | N = 0:14756 | | |

(NOTE):
The default value for operating bands with which only support SCS spaced channel raster(s) is M = 3.

Alt-2: indicate the frequency location of the lowest or highest subcarrier of the NR SSB
   Indicate an offset from a frequency reference point, the offset may be RB granularity or subcarrier granularity or combination of RB and subcarrier granularity
Option 2: indicate NR carrier information in the shared spectrum and indicate NR SSB location in the NR carrier
   Center of NR carrier
      the NR carrier center subcarrier location, e.g. indicate an offset from a reference point to the center subcarrier of the NR carrier, or indicate an Absolute Radio-Frequency Channel Number (ARFCN) of the center of NR carrier
   NR carrier BW
   SSB Subcarrier Offset (k_{ssb})
      Corresponds to k_{SSB} (see 3GPP TS 38.213), which is the frequency domain offset between SSB and the overall resource block grid in number of subcarriers, i.e. (offset between the edge of the SS/PBCH RBs and the edge of the data RBs).
   Lowest RB location (or lowest subcarrier location) of SSB after SSB Subcarrier Offset (kssb) is resolved (i.e. SSB is shifted k_{ssb} subcarriers in frequency domain)
      Option 1: indicate the Lowest RB index (Common RB index, or Physical RB index).
         Also indicate the Common RB 0 or Physical RB 0 location, e.g. reference point of the subcarrier 0 of Common RB 0 or Physical RB 0
      Option 2: indicate the lowest frequency location of SSB
         E.g. indicate an offset from a reference point

For the above parameter indication to 6G UE, it could be by RRC, MAC-CE, or DCI signalling.

After obtaining the time and frequency locations of NR SSB, 6G UE could rate match around the NR SSB:
Option 1: RE-level rate matching. 6G UE could use REs not occupied by NR SSBs, this could maximize the spectrum efficiency
Option 2: RB-level rate matching. For an RB in 6G carrier, if one or multiple REs are occupied by NR SSBs, the RB is rate matched by 6G UE. This option is simple, but will waste some REs, decreasing the spectrum efficiency.

For RB-level rate matching around NR SSB for 6G UE, another scheme could be used to indicate the time and frequency location of NR SSB:
Time-domain location: the same as above
Frequency-domain location
   Indicate the frequency location of lowest subcarrier or lowest RB of NR SSB
      E.g. indicate the RB index in 6G carrier for the lowest location of NR SSB
   Indicate the number of RBs occupied by NR SSB
      E.g. 20 or 21 RBs with the SCS of NR SSB, if not indicated, 6G UE assume the value is 20 (or 21).

(2) 6G BS indicate 6G UE the NR CORESET0 configuration in the shared spectrum: CORESET 0 is a type of CORESET (Control Resource Set) which carries PDCCH/DCI for SIB1. A number of consecutive resource blocks and a number of consecutive symbols are configured for the CORESET of the Typeo-PDCCH CSS set (i.e. CORESET0).

In addition, 6G BS also indicates NR Common RB 0 or Physical RB 0 location, e.g. frequency location of the subcarrier 0 of Common RB 0 or Physical RB 0.

6G BS indicates the time-frequency location of CORESET0 to 6G UE, so 6G UE could rate match around the REs (or RBs-symbols) occupied by 5G.
Option 1: BS directly indicate the RBs and symbols of NR CORESET0
   Frequency-domain: starting RB of CORESET0 and length of CORESET0
   Time-domain: symbol locations of CORESET0 and periodicity of CORESET0.
   Note: In frequency-domain, one or multiple CORESET0 may be indicated to UEs.
Option 2: BS indicates time-frequency location of NR SSB block and corresponding CORESET0
   SSB location indication refer to above solution
   For corresponding CORESET0 indication, one or multiple following information is configured:
      the existence of NR CORESET0
         This is because if the SSB is not cell-defined SSB in NR, there is no corresponding NR CORESET0
      Frequency-domain location of CORESET0 if there is corresponding CORESET
         BS indicate the SSB SCS, PDCCH for SIB1 SCS (note SIB1, PDCCH for SIB1 and CORESET0 have the same SCS)
         According to {SSB, PDCCH} SCS, 6G UE could find the exact used table for CORESET0 configuration from Table 13-1 to Table 13-10 in 3GPP TS 38.213 V17.4.0
         Configuration Index in the exact used table for CORESET0 configuration
         according to the index (e.g. 4 bits for the index), 6G UE could find the row in the table for CORESET0 configuration, i.e. could obtain the frequency location of CORESET0 and time duration of CORESET0
         Note: Configuration index can be regarded as IE (Information Element) controlResourceSetZero in 3GPP TS 38.331
      Time-domain location of CORESET0 if there is corresponding CORESET
         BS indicate the SSB SCS, PDCCH for SIB1 SCS (note SIB1, PDCCH for SIB1 and CORESET0 have the same SCS)
         According to {SSB, PDCCH} SCS, 6G UE could find the exact used table for PDCCH monitoring occasions in CORESET0
         Time Configuration Index in the exact used table
         according to the index (e.g. 4 bits for the index), 6G UE could find the row in the table for PDCCH monitor occasion for SIB1, i.e. could obtain the time-domain location (including periodicity) for PDCCH in CORESET0
         Note: Time Configuration index can be regarded as IE (Information Element) searchSpaceZero in 3GPP TS 38.331

(3) 6G BS indicate 6G UE the NR CSI-RS configuration in the shared spectrum: 6G BS indicates the NR carrier information in the shared spectrum to 6G UE, including center frequency of NR carrier, NR carrier bandwidth, and/or the center of the subcarrier 0 of a common resource block or a PRB, and/or the frame timing (e.g. boundary of a frame/subframe/slot).

In addition, 6G BS indicates the REs occupied by NR CSI-RS to 6G UE, so 6G UE could rate match around these REs. To indicate the resource element mapping of a CSI-RS resource in time and frequency domain, one or multiple of the following information is included:
frequencyDomainAllocation
   Frequency domain allocation within a physical resource block in accordance with TS 38.211, clause 7.4.1.5.3
nrofPorts
   Number of ports
firstOFDMSymbolInTimeDomain
   Time domain allocation within a physical resource block. The field indicates the first OFDM symbol in the PRB used for CSI-RS. See TS 38.211, clause 7.4.1.5.3.
firstOFDMSymbolInTimeDomain2
   Time domain allocation within a physical resource block. See TS 38.211, clause 7.4.1.5.3.
cdm-Type
   CDM type (see TS 38.214, clause 5.2.2.3.1).
Density
   Density of CSI-RS resource measured in RE/port/PRB (see TS 38.211, clause 7.4.1.5.3).
freqBand
   Wideband or partial band CSI-RS, (see TS 38.214, clause 5.2.2.3.1).
Note: more details for above parameters refer to IE CSI-RS-ResourceMapping in TS 38.331
CSI-ResourcePeriodicityAndOffset
   a periodicity and a corresponding offset for periodic and semi-persistent CSI resources
Numerology of NR CSI-RS, including SCS and CP
NR Common RB 0 or Physical RB 0 location, e.g. frequency location of the subcarrier 0 of Common RB 0 or Physical RB 0 in the NR carrier

6G BS may indicate one or multiple NR CSI-RS resources to 6G UE for rate matching.

(3A) 6G BS indicate 6G UE the NR CORESET configuration in the shared spectrum: 6G BS indicates the NR carrier information in the shared spectrum to 6G UE, including center frequency of NR carrier, NR carrier bandwidth, and/or the center of the subcarrier 0 of a common resource block or a PRB, and/or the frame timing (e.g. boundary of a frame/subframe/slot).

In addition, 6G BS indicates the REs (or symbols and RBs) occupied by NR CORESET to 6G UE, so 6G UE could rate match around these REs (or symbols and RBs). To indicate the resource element mapping of a CORESET in time-and frequency domain, one or multiple of the following information is included:
frequencyDomainResources
   Frequency domain resources for the CORESET. E.g. a bitmap is used, each bit corresponds a group of 6 RBs
duration
   Contiguous time duration of the CORESET in number of symbols
   6G UE assumes a NR CORESET starts from the first symbol of a NR slot
Numerology of NR CORESET, including SCS and CP
Note: more details for above parameters refer to IE ControlResourceSet in TS 38.331
Numerology of NR CORESET, including SCS and CP.
NR Common RB 0 or Physical RB 0 location, e.g. frequency location of the subcarrier 0 of Common RB 0 or Physical RB 0 in the NR carrier

6G BS may indicate one or multiple NR CORESET resources to 6G UE for rate matching.

(4) 6G BS indicate 6G UE the NR SRS configuration in the shared spectrum: 6G BS indicates the NR carrier information in the shared spectrum to 6G UE, including center frequency of NR carrier, NR carrier bandwidth, and/or the center of the subcarrier 0 of a common resource block or a PRB, and/or the frame timing (e.g. boundary of a frame/subframe/slot).

In addition, 6G BS indicates the REs occupied by NR SRS to 6G UE, so 6G UE could rate match around these REs. To indicate the resource element mapping of an SRS resource in time and frequency domain, one or multiple of the following information is included:
nrofSRS-Ports
   Number of SRS ports.
transmissionComb
   Comb value (2 or 4 or 8) and comb offset (see TS 38.214, clause 6.2.1).
resourceMapping, including startPosition, nrofSymbols, repetitionFactor
   OFDM symbol location of the SRS resource within a slot including nrofSymbols (number of OFDM symbols), startPosition (value 0 refers to the last symbol, value 1 refers to the second last symbol, and so on) and repetitionFactor (see TS 38.214, clause 6.2.1 and TS 38.211, clause 6.4.1.4).
freqDomainPosition
   frequency domain locations for SRS
periodicityAndOffset
   Periodicity and slot offset for this SRS resource
Note: more details for above parameters refer to IE SRS-Resource, SRS-ResourceSet in TS 38.331
Numerology of NR SRS, including SCS and CP
NR Common RB 0 or Physical RB 0 location, e.g. frequency location of the subcarrier 0 of Common RB 0 or Physical RB 0 in the NR carrier

6G BS may indicate one or multiple NR SRS resources to 6G UE for rate matching.

(5) 6G BS indicate 6G UE the NR PRACH configuration in the shared spectrum: 6G BS indicates the NR carrier information in the shared spectrum to 6G UE, including center frequency of NR carrier, NR carrier bandwidth, and/or the center of the subcarrier 0 of a common resource block or a PRB, and/or the frame timing (e.g. boundary of a frame/subframe/slot).

In addition, 6G BS indicates the REs occupied by NR PRACH to 6G UE, so 6G UE could rate match around these REs. To indicate the resource element mapping of a PRACH resource in time and frequency domain, one or multiple of the following information is included:
prach-ConfigurationIndex
   PRACH configuration index. (see TS 38.211, clause 6.3.3.2). The index indicates a row in the PRACH configuration table, e.g. Table 6.3.3.2-2. According to the indicated row in the table, the PRACH time-domain location is known by 6G UEs
msg1-FrequencyStart
   Offset of lowest PRACH transmission occasion in frequency domain with respective to NR PRB 0. (see TS 38.211, clause 6.3.3.2).
msg1-FDM
   The number of PRACH transmission occasions FDMed in one time instance. (see TS 38.211, clause 6.3.3.2).
number of RBs expressed with a numerology
   the numerology and number of RBs are determined according to the length and SCS for PRACH as in Table 6.3.3.2-1 in TS 38.211, where the length and SCS for PRACH is determined according to the above prach-ConfigurationIndex
Note: more details for above parameters refer to IE RACH-ConfigGeneric in TS 38.331
NR Common RB 0 or Physical RB 0 location, e.g. frequency location of the subcarrier 0 of Common RB 0 or Physical RB 0 in the NR carrier

6G BS may indicate one or multiple NR PRACH resources to 6G UE for rate matching.

Furthermore, 6G BS may also indicate the time and frequency resources for NR PUCCH transmission to 6G UE for rate matching.

The technical benefit(s)/advantage(s) of Embodiment 1: 6G BS indicates to 6G UE the configuration of 5G NR signal or channel configuration, so 6G UE can rate match around these REs to improve spectrum sharing efficiency.

### Embodiment 2

6G BS indicates some candidate RE resources (candidate RM resources) for 6G UE Rate Matching, indication method is given in Embodiment 1.

Semi-static RM resources+dynamic release: The candidate RM resources (e.g. resources may be used by NR SSB, NR CSI-RS, NR CORESET, NR SRS, NR PUCCH, NR PRACH, etc.) could be indicated by SIB, RRC, or MAC-CE. Furthermore, one candidate RM resource could be released (or de-activated) by MAC-CE or DCI to enable dynamic sharing. E.g. DCI indicates to 6G UE that the candidate RM resource is not mapped by 5G BS/UE, so it can be used by 6G UE, and no rate matching around the candidate RM resource is required. If no release signaling is received by 6G UE, the 6G UE assumes the candidate RM resource should be rate matched by default.

After receiving the release indication at 6G UE, the UE:
Option 1: Rate Match around the candidate RM resource according to the release indication. For the next transmission on the candidate RM resource, the UE should assume that the RM resource should be rate matched by default.
Option 2: Rate Match around the candidate RM resource according to the release indication, and the UE assumes the candidate RM resource will not rate matched in the next transmissions. When the UE receives RM resource activation indication, the UE assumes the candidate RM resource shall be rate matched in the next transmissions.

For the release signal design, it can be:
Option 1: by a bitmap
   A bitmap is used for release indication, where a bit is corresponding to one candidate RM resource. One example is as follows with reference to FIG. 19. 6G BS configures 4 candidate RM resources, where a RM resource may be used by NR SSB. But NR carrier actually transmit 3 NR SSBs. So the one RM resource could be released for 6G UEs. So 6G BS uses 4 bits to indicate the releasement, e.g. 0100 to indicate that the second candidate RM resource is released and can be used by 6G UEs.
Option 2: indicate the released candidate RM resource ID
   Each candidate RM resource is configured a resource ID. By indicating the ID in the release signal, the 6G UE knows which candidate RM resource is released.

The technical benefit(s)/advantage(s) of Embodiment 2: Semi-statically configure candidate rate matching resources for 6G UEs, and dynamic signaling to release some RM resources to support dynamic and flexible spectrum sharing between NR and 6G.

### Embodiment 3

In the shared spectrum band with 5G NR, 6G carrier may have multiple SSB patterns.
6G SSB pattern 1 (one example is given in FIG. 20 “Pattern 1”)
   Within a time burst, e.g. 5 ms, the number of candidate SSBs is M1, M1 is a relative large number. This is because 6G have more SSB beams due to increased number of antennas
   This can be used when 6G SSB is not overlapped with 5G SSB in the frequency-domain, so all the time burst could be used to transmit 6G SSB
6G SSB pattern 2 (one example is given in FIG. 20 “Pattern 2”)
   Within a time burst, e.g. 5 ms, the number of candidate SSBs is M2, M2 <M1
   This can be used when 6G SSB is overlapped with 5G SSB in the frequency-domain, so only partial of the time burst could be used to transmit 6G SSB, some part of the time burst may be used by 5G SSB.

When the traffic load for 6G is light, e.g. small number of 6G UEs in the early deployment of 6G, 6G carrier or 6G BWP could occupy a small bandwidth in the shared spectrum, e.g. FDM coexistence between NR and 6G, so there is no overlapped between 6G SSB and NR SSB. Therefore, SSB pattern 1 could be utilized for 6G carrier.

When the traffic load for 6G is heavy, 6G carrier or 6G BWP could occupy a large bandwidth in the shared spectrum, e.g. the whole carrier bandwidth of the shared spectrum. To achieve the best sync performance for 6G UE, 6G SSB may be located on the center of 6G BWP, which is similar to 5G SSB deployment. So 6G SSB will be overlapped with NR SSB in the frequency domain. Therefore, SSB pattern 2 could be utilized for 6G carrier.

In summary, 6G SSB pattern and/or the 6G SSB location may be dynamically updated by BS, e.g. according to the traffic load of 6G. For a UE in power saving mode, e.g. IDLE state, the SSB pattern and/or the location may be changed, so the SSB pattern and/or the location should be indicated to the UE when the UE is wakeup, e.g. by paging signal.

One example is given below. When a UE is in power saving mode, e.g. IDLE state, the UE stay in a small-size BWP. For example, the BW of the BWP is much smaller than 6G SSB, and the UE use RS (e.g. Tracking RS, CSI-RS) for coarse synchronization, AGC setting. On receiving paging, the paging indicate one or multiple following information:
6G SSB pattern
   E.g. pattern 1 or pattern 2
6G SSB location
   Frequency location of SSB
      Alt-1: GSCN (Global Synchronization Channel Number)
      Alt-2: an offset from a frequency reference point, where the frequency reference point is predefined or configured. According to the offset, UE could know the lowest RB or highest RB or center of 6G SSB
      Alt-3: some candidate 6G SSB location in frequency-domain is pre-defined or configured. For example, a candidate location has an index. Paging indicate which candidate location is for 6G SSB transmission, e.g. indicate the location index.
   Time location of SSB: symbols and/or periodicity for 6G SSB
Active BWP
   Paging indicates a BWP (switch-to BWP), the UE is switched to the BWP after receiving paging.

See examples explained earlier, e.g. in relation to FIG. 21.

The technical benefit(s)/advantage(s) of Embodiment 3: Paging indicates 6G SSB location, and active BWP location, reduce the UE blind search effort, achieve UE power saving.

Summary of some of the main points discussed above:
RE-level dynamic spectrum sharing between NR and 6G
6G BS indicates time-frequency resource of NR SSBs to 6G UE
   Time-domain: Indicate timing reference point (NR half-frame boundary), SCS of NR SSB, Periodicity of NR SSB burst set, Actually Transmitted NR SS/PBCH Block
   Frequency-domain:
      Opt-1: indicate GSCN (Global Synchronization Channel Number) of NR SSB
      Opt-2: indicate NR carrier information: Center of NR carrier, NR carrier BW, kssb (offset between the edge of the SS/PBCH RBs and the edge of the data RBs), Lowest RB index of SSB after kssb is resolved
6G BS indicate the existence of NR CORESETo associated to an SSB
   Indicate time-frequency location of CORESET0 for SIB1: SCS of CORESET0, ControlResourceSetZero (8 bit)
6G BS indicates NR CSI-RS resources to 6G UE: Periodicity and Offset, frequencyDomainAllocation, nrofPorts, firstOFDMSymbolInTimeDomain, cdm-Type, density
Semi-static RM resources+dynamic release (de-activate) RM resources
   6G SIB/RRC indicates semi-static RM resources
   6G MAC-CE/DCI indicates some semi-static RM resources are released
      UE wakeup procedure in the shared carrier.
   There are multiple 6G SSB patterns, which depends on whether 6G SSB and NR SSB are overlapped in frequency
   Paging indicates: 6G SSB location (e.g. GSCN), 6G SSB pattern, Switch-to BWP

The methods are performed by a device or an apparatus, e.g. by a processor of the device or apparatus executing instructions stored in a memory. The instructions, when executed, cause the device or apparatus to perform the methods. The various options and embodiments may be combined in different permutations.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method, performed by an apparatus, the method comprising:
receiving an indication of first time-frequency resources associated with wireless transmissions on a first radio access technology (RAT) on a first frequency band; and
wirelessly communicating on a second RAT on a second frequency band, the second frequency band at least partially overlapping in frequency domain with the first frequency band; and
wherein the wirelessly communicating occurs on second time-frequency resources excluding the first time-frequency resources.

2. The method of claim 1, wherein the wirelessly communicating comprises communicating on the second time-frequency resources excluding the first time-frequency resources by rate-matching or puncturing to exclude communicating on the first time-frequency resources.

3. The method of claim 1, further comprising:
prior to the wirelessly communicating, receiving information configuring a wireless communication for the apparatus on the second RAT, the wireless communication configured on the second time-frequency resources and the first time-frequency resources.

4. The method of claim 3, wherein receiving the information configuring the wireless communication comprises receiving scheduling information scheduling the wireless communication, the wireless communication being scheduled on the second time-frequency resources and the first time-frequency resources.

5. The method of claim 4, wherein the scheduling information schedules the wireless communication on a plurality of resource blocks (RBs), at least one RB of the plurality of RBs including at least some of the first time-frequency resources, and wherein the wirelessly communicating comprises performing the wireless communication on the plurality of RBs excluding any RB that includes some or all of the first time-frequency resources.

6. The method of claim 1, wherein the second RAT is associated with both a first synchronization signal block (SSB) time-frequency location pattern and a second SSB time-frequency location pattern for transmission of SSBs on the second RAT on the second frequency band, and wherein the method further comprises:
receiving, at the apparatus, an indication of whether the first SSB time-frequency location pattern or the second SSB time-frequency location pattern is being used.

7. The method of claim 6, wherein:
the first SSB time-frequency location pattern includes SSBs transmitted on the second RAT on the second frequency band on different frequency resources than SSBs transmitted on the first RAT on the first frequency band, and
the second SSB time-frequency location pattern includes SSBs transmitted on the second RAT on the second frequency band on frequency resources that at least partially overlap with the frequency resources of SSBs transmitted on the first RAT on the first frequency band, but multiplexed in time.

8. An apparatus comprising:
at least one processor coupled with a memory storing processor-executable instructions that, when executed by the at least one processor, cause the apparatus to:
receive an indication of first time-frequency resources associated with wireless transmissions on a first radio access technology (RAT) on a first frequency band; and
wirelessly communicate on a second RAT on a second frequency band, the second frequency band at least partially overlapping in frequency domain with the first frequency band; and
wherein the wirelessly communicating occurs on second time-frequency resources excluding the first time-frequency resources.

9. The apparatus of claim 8, wherein the wirelessly communicating is performed by communicating on the second time-frequency resources excluding the first time-frequency resources by rate-matching or puncturing to exclude communicating on the first time-frequency resources.

10. The apparatus of claim 8, wherein the at least one processor, when executing the instructions, further causes the apparatus to:
prior to the wirelessly communicating, receive information configuring a wireless communication for the apparatus on the second RAT, the wireless communication configured on the second time-frequency resources and the first time-frequency resources.

11. The apparatus of claim 10, wherein the apparatus being caused to receive the information configuring the wireless communication comprises the apparatus being caused to receive scheduling information scheduling the wireless communication, the wireless communication scheduled on the second time-frequency resources and the first time-frequency resources.

12. The apparatus of claim 11, wherein the scheduling information schedules the wireless communication on a plurality of resource blocks (RBs), at least one RB of the plurality of RBs including at least some of the first time-frequency resources, and wherein the wirelessly communicating is performed by performing the wireless communication on the plurality of RBs excluding any RB that includes some or all of the first time-frequency resources.

13. The apparatus of claim 8, wherein the second RAT is associated with both a first synchronization signal block (SSB) time-frequency location pattern and a second SSB time-frequency location pattern for transmission of SSBs on the second RAT on the second frequency band, and wherein the at least one processor, when executing the instructions, further causes the apparatus to:
receive, at the apparatus, an indication of whether the first SSB time-frequency location pattern or the second SSB time-frequency location pattern is being used.

14. A device comprising:
at least one processor coupled with a memory storing processor-executable instructions that, when executed by the at least one processor, cause the device to:
transmit, to an apparatus, an indication of first time-frequency resources associated with wireless transmissions on a first radio access technology (RAT) on a first frequency band; and
wirelessly communicate with the apparatus on a second RAT on a second frequency band, the second frequency band at least partially overlapping in frequency domain with the first frequency band; and
wherein the wirelessly communicating occurs on second time-frequency resources excluding the first time-frequency resources.

15. The device of claim 14, wherein the wirelessly communicating is performed by communicating on the second time-frequency resources excluding the first time-frequency resources by rate-matching or puncturing to exclude communicating on the first time-frequency resources.

16. The device of claim 14, wherein the at least one processor, when executing the instructions, further causes the device to:
prior to the wirelessly communicating, transmit information configuring a wireless communication for the apparatus on the second RAT, the wireless communication configured on the second time-frequency resources and the first time-frequency resources.

17. The device of claim 16, wherein the device being caused to to transmit the information configuring the wireless communication comprises the device being caused to transmit scheduling information scheduling the wireless communication, the wireless communication being scheduled on the second time-frequency resources and the first time-frequency resources.

18. The device of claim 17, wherein the scheduling information schedules the wireless communication on a plurality of resource blocks (RBs), at least one RB of the plurality of RBs including at least some of the first time-frequency resources, and wherein the wirelessly communicating is performed by performing the wireless communication on the plurality of RBs excluding any RB that includes some or all of the first time-frequency resources.

19. The device of claim 14, wherein the second RAT is associated with both a first synchronization signal block (SSB) time-frequency location pattern and a second SSB time-frequency location pattern for transmission of SSBs on the second RAT on the second frequency band, and wherein the instructions, when executed by the at least one processor, cause the device to:
transmit, to the apparatus, an indication of whether the first SSB time-frequency location pattern or the second SSB time-frequency location pattern is being used.

20. The device of claim 19, wherein:
the first SSB time-frequency location pattern includes SSBs transmitted on the second RAT on the second frequency band on different frequency resources than SSBs transmitted on the first RAT on the first frequency band, and
the second SSB time-frequency location pattern includes SSBs transmitted on the second RAT on the second frequency band on frequency resources that at least partially overlap with the frequency resources of SSBs transmitted on the first RAT on the first frequency band, but multiplexed in time.
